(19) United States
(12) Patent Application Publication
(10) Pub. No.: US 2025/0300794 A1
(43) Pub. Date: Sep. 25, 2025

(54) UE CAPABILITY SHARING

(71) Applicant: ZTE Corporation, Shenzhen (CN)

(72) Inventors: Xingguang WEI, Shenzhen (CN); Xianghui HAN, Shenzhen (CN); Jing SHI, Shenzhen (CN); Wei GOU, Shenzhen (CN); Shuaihua KOU, Shenzhen (CN)

(73) Assignee: ZTE Corporation, Shenzhen (CN)

(21) Appl. No.: 19/230,580

(22) Filed: Jun. 6, 2025

Related U.S. Application Data
(63) Continuation of application No. PCT/CN2023/091748, filed on Apr. 28, 2023.

(51) Int. Cl. H04L 5/00; H04W 76/28

(52) U.S. Cl. CPC H04L 5/0098; H04L 5/0044; H04W 76/28

(57) ABSTRACT

A method for handling transmissions in a wireless cellular access network includes determining sharing at least one capability from at least one first band or cell to at least one second band or cell, and indicating capability sharing information to a wireless access network node. This provides a flexible mechanism for enabling UE capability sharing to thereby increase a UE capability utilization efficiency.

### TECHNICAL FIELD

This disclosure generally relates to handling transmissions in a wireless cellular access network and is specifically directed to mechanisms for sharing user equipment (UE) capabilities.

### BACKGROUND

Based on the existing LTE and NR system, a user equipment (UE) (i.e., wireless terminal device) indicates UE capabilities to the base station (i.e., wireless network access node). Base station configures configurations and schedules transmissions according to the corresponding UE capabilities. Most of the UE capabilities are defined per band or per cell. Even if the cell in one band is not activated, not configured, or not scheduled, the UE can't share its capabilities to the other activated cell in the same band or in another band. For example, a basic UE capability is to receive one PDSCH (Physical Downlink Shared Channel) per slot per cell. If the UE is configured with two cells, the UE has the capability to receive two PDSCHs per slot with one for each cell. However, if one of the cells is deactivated, with the existing LTE and NR system, the UE can still only receive one PDSCH per slot in the activated cell. The UE capability for the other band is wasted.

### SUMMARY

This disclosure relates to handling transmissions in a wireless cellular access network and is specifically directed to a mechanism for sharing UE capabilities. The various example embodiments are particularly directed to a new method to share the UE capability of a cell or band that is not activated, not configured, or not scheduled during one time period to another cell or band that is activated, configured, or scheduled. In accordance with various embodiments, the new methods can recycle the UE capabilities from a cell or band that is not activated, not configured, or not scheduled during one time period to another cell or band. As a result, UE capability utilization efficiency can be increased.

In some exemplary implementations, a method performed by a wireless terminal device for handling transmissions includes sharing at least one capability from at least one first band or cell to at least one second band or cell, and indicating capability sharing information to a wireless access network node. Indicating the capability sharing information to the wireless access network node may include indicating support of one band combination including the at least one first band and the at least one second band to the wireless access network node. The method may include receiving, from the wireless access network node, a configuration of the at least one second band and no configuration of the at least one first band, and sharing the at least one capability from the at least one first band to the at least one second band.

In some exemplary implementations, which may be combined with any of the other exemplary implementations disclosed herein, the method may also include receiving, from the wireless access network node, a configuration of one or more cells in the at least one first band and a configuration of one or more cells in the at least one second band, determining that all of the one or more cells in the at least one first band are deactivated, and sharing the at least one capability from the at least one first band to the at least one second band. Similarly, the method may include receiving, from the wireless access network node, a configuration of the at least one first cell and a configuration of the at least one second cell, determining that the at least one first cell is deactivated, and sharing the at least one capability from the at least one first cell to the at least one second cell, wherein the at least one first cell and the at least one second cell are in a same band or two separate bands.

In some exemplary implementations, which may be combined with any of the other exemplary implementations disclosed herein, the method may also include receiving, from the wireless access network node, a configuration of one or more cells in the at least one first band and a configuration of one or more cells in the at least one second band, determining that all of the one or more cells in the at least one first band are in a dormant state, and sharing the at least one capability from the at least one first band to the at least one second band. The method may also include receiving, from the wireless access network node, a configuration of the at least one first cell and a configuration of the at least one second cell, determining that the at least one first cell is in a dormant state, and sharing the at least one capability from the at least one first cell to the at least one second cell, wherein the at least one first cell and the at least one second cell are in a same band or two separate bands. The method may also include receiving, from the wireless access network node, a configuration of one or more cells in the at least one first band and a configuration of one or more cells in the at least one second band, determining that all of the one or more cells in the at least one first band are in a discontinuous reception (DRX) off state, and sharing the at least one capability from the at least one first band to the at least one second band. The method may also include receiving, from the wireless access network node, a configuration of the at least one first cell and a configuration of the at least one second cell, determining that the at least one first cell is in a discontinuous reception (DRX) off state, and sharing the at least one capability from the at least one first cell to the at least one second cell, wherein the at least one first cell and the at least one second cell are in a same band or two separate bands.

In some exemplary implementations, which may be combined with any of the other exemplary implementations disclosed herein, the method may also include receiving, from the wireless access network node, a configuration of one or more cells in the at least one first band and a configuration of one or more cells in the at least one second band, determining that all of the one or more cells in the at least one first band are not scheduled in a time unit, and sharing the at least one capability from the at least one first band to the at least one second band during the time unit. The method may also include receiving, from the wireless access network node, a configuration of one or more cells in the at least one first band and a configuration of one or more cells in the at least one second band, determining that all of the one or more cells in the at least one first band are configured as downlink in a time unit, and sharing at least one uplink-related capability from the at least one first band to the at least one second band during the time unit. The method may also include receiving, from the wireless access network node, a configuration of one or more cells in the at least one first band and a configuration of one or more cells in the at least one second band, determining that all of the one or more cells in the at least one first band are configured as uplink in a time unit, and sharing at least one downlink-related capability from the at least one first band to the at least one second band during the time unit.

In some exemplary implementations, which may be combined with any of the other exemplary implementations disclosed herein, the method may also include receiving, from the wireless access network node, a configuration of the at least one first cell and a configuration of the at least one second cell, determining that the at least one first cell is not scheduled in a time unit, and sharing the at least one capability from the at least one first cell to the at least one second cell during the time unit, wherein the at least one first cell and the at least one second cell are in a same band or two separate bands. The method may also include receiving, from the wireless access network node, a configuration of the at least one first cell and a configuration of the at least one second cell, determining that the at least one first cell is configured as downlink in a time unit, and sharing at least one uplink-related capability from the at least one first cell to the at least one second cell during the time unit, wherein the at least one first cell and the at least one second cell are in a same band or two separate bands. The method may also include receiving, from the wireless access network node, a configuration of the at least one first cell and a configuration of the at least one second cell, determining that the at least one first cell is configured as uplink in a time unit, and sharing at least one downlink-related capability from the at least one first cell to the at least one second cell during the time unit, wherein the at least one first cell and the at least one second cell are in a same band or two separate bands.

In some exemplary implementations, which may be combined with any of the other exemplary implementations disclosed herein, the at least one first band comprises two or more first bands. The method may include receiving, from the wireless access network node, a configuration of one or more cells in the two or more first bands and a configuration of one or more cells in the at least one second band, determining that all of the one or more cells in the two or more first bands are deactivated, and sharing the at least one capability from at least one of the two or more first bands to the at least one second band. The method may also include determining that all of the one or more cells in the two or more first bands are in a dormant state, and sharing the at least one capability from at least one of the two or more first bands to the at least one second band. The method may also include determining that all of the one or more cells in the two or more first bands are in a discontinuous reception (DRX) off state, and sharing the at least one capability from at least one of the two or more first bands to the at least one second band. The method may also include determining that all of the one or more cells in the two or more first bands are not scheduled in a time unit, and sharing the at least one capability from at least one of the two or more first bands to the at least one second band during the time unit.

In some exemplary implementations, which may be combined with any of the other exemplary implementations disclosed herein, the at least one first cell comprises two or more first cells. The method may include receiving, from the wireless access network node, a configuration of the two or more first cells and a configuration of the at least one second cell, determining that the two or more first cells are deactivated, and sharing the at least one capability from at least one of the two or more first cells to the at least one second cell, wherein the two or more first cells and the at least one second cell are in a same band or separate bands. The method may also include determining that the two or more first cells are in a dormant state, and sharing the at least one capability from at least one of the two or more first cells to the at least one second cell, wherein the two or more first cells and the at least one second cell are in a same band or separate bands. The method may also include determining that the two or more first cells are in a discontinuous reception (DRX) off state, and sharing the at least one capability from at least one of the two or more first cells to the at least one second cell, wherein the two or more first cells and the at least one second cell are in a same band or separate bands. The method may also include determining that the two or more first cells are not scheduled in a time unit, and sharing the at least one capability from at least one of the two or more first cells to the at least one second cell during the time unit, wherein the two or more first cells and the at least one second cell are in a same band or separate bands.

In some exemplary implementations, which may be combined with any of the other exemplary implementations disclosed herein, an amount of the at least one capability from the at least one first band or cell is represented as X1, and wherein an amount of a capability of the at least one second band or cell without sharing is represented as X2. The method may include sharing the at least one capability from the at least one first band or cell to the at least one second band or cell such that a shared capability of the at least one second band or cell is X, wherein X=X1+X2. In some embodiments, the at least one capability from the at least one first band or cell and the capability of the at least one second band or cell is a number of Physical Downlink Shared Channel (PDSCH) per slot, wherein the wireless terminal device receives X=X1+X2 Frequency Domain Multiplexing (FDM) PDSCHs per slot for the at least one second band or cell. In some embodiments, the at least one capability from the at least one first band or cell and the capability of the at least one second band or cell is a number of Downlink (DL) Bandwidth Part (BWP) per cell, wherein the wireless terminal device can activate X=X1+X2 DL BWPs per cell for the at least one second band or cell. The method may also include sharing the at least one capability from the at least one first band or cell to the at least one second band or cell such that a shared capability of the at least one second band or cell is X, wherein X2<X≤X1+X2, and wherein X is configured by high layer configuration.

In some exemplary implementations, which may be combined with any of the other exemplary implementations disclosed herein, the first band and the second band are a band pair, and wherein an amount of the at least one capability of the at least one first band and an amount of capability of the at least one second band without sharing is represented as X1. The method may include sharing the at least one capability from the at least one first band to the at least one second band such that a shared capability of the at least one second band is 2*X1. In another embodiment, an amount of the at least one capability of the at least one first band and an amount of capability of the at least one second band without sharing is set for the entire wireless terminal device and is represented as X1, and the method includes sharing the at least one capability from the at least one first band to the at least one second band such that a shared capability of the at least one second band is 2*X1.

In some exemplary implementations, which may be combined with any of the other exemplary implementations disclosed herein, the wireless terminal device is configured with cells in K bands, including the at least one first band and the at least one second band, and the wireless terminal device indicates values X₁, X₂, . . . , X_{K} for each band for the at least one capability, where K is an integer and K≥3. The method may include sharing the at least one capability for all K bands except for the second band to the second band such that a shared capability (X) for the second band is X=Σₖ₌₁^{K}Xₖ, where k is an integer and 1≤k≤K. Similarly, the wireless terminal device may be configured with K cells, including the at least one first cell and the at least one second cell, and wherein the wireless terminal device indicates values X₁, X₂, . . . , X_{K} for each cell for the at least one capability, where K is an integer and K≥3. The method may include sharing the at least one capability for all K cells except for the second cell to the second cell such that a shared capability (X) for the second cell is X=Σₖ₌₁^{K}Xₖ, where k is an integer and 1≤k≤K.

In some exemplary implementations, which may be combined with any of the other exemplary implementations disclosed herein, the wireless terminal device is configured with cells in K bands, including the at least one first band and the at least one second band, and wherein the wireless terminal device indicates values X₁, X₂, . . . , X_{K} for each band for the at least one capability, where K is an integer and K≥3. The method may include sharing the at least one capability for all K bands except for the second band to the second band such that a shared capability (X) for the second band is and Xᵢ<X≤Σₖ₌₁^{K}Xₖ, where k is an integer and 1≤k≤K and Xᵢ is an indicated value for the second band, and wherein X is configured by high layer configuration. Similarly, the wireless terminal device may be configured with K cells, including the at least one first cell and the at least one second cell, and wherein the wireless terminal device indicates values X₁, X₂, . . . , X_{K} for each cell for the at least one capability, where K is an integer and K≥3. The method may include sharing the at least one capability for all K cells except for the second cell to the second cell such that a shared capability (X) for the second cell is and Xᵢ<X≤Σₖ₌₁^{K}Xₖ, where k is an integer and 1≤k≤K and Xᵢ is an indicated value for the second cell, and wherein X is configured by high layer configuration.

In some exemplary implementations, which may be combined with any of the other exemplary implementations disclosed herein, the wireless terminal device is configured with a combination of K bands, including the at least one first band and the at least one second band, and wherein the wireless terminal device indicates a value X₁ for each band for the at least one capability, where K is an integer and K≥3. The method may include sharing the at least one capability for all K bands except for the second band to the second band such that a shared capability (X) for the second band is X=K·X1. Similarly, the wireless terminal device may be configured with K bands, including the at least one first band and the at least one second band, and wherein the wireless terminal device indicates a per-wireless terminal device value X₁ for each band for the at least one capability, where K is an integer and K≥3. The method may include sharing the at least one capability for all K bands except for the second band to the second band such that a shared capability (X) for the second band is X=K·X1.

In some exemplary implementations, which may be combined with any of the other exemplary implementations disclosed herein, the method may include acquiring timing information for the at least one second band or cell based on the Synchronization Signal Block (SSB) or other Tracking Reference Signal (TRS) or Channel State Information Reference Signal (CSI-RS) transmitted on the at least one second band or cell. The method may include indicating, to the wireless access network node, a band pair including the at least one first band and the at least one second band, wherein the at least one capability for one band in the band pair can be shared to another band in the band pair. The method may include indicating, to the wireless access network node, a band pair including the at least one first band and the at least one second band, and a sharing direction from the at least one first band to the at least one second band. The method may include indicating, to the wireless access network node, the band including the at least one first cell and the at least one second cell as a band that supports sharing of the at least one capability from the at least one first cell to the at least one second cell, wherein the at least one first cell and the at least one second cell are within a same band. The method may include indicating, to the wireless access network node, a band combination comprising the at least one first band and the at least one second band, wherein the at least one capability for one or more bands in the band combination can be shared to another band in the band combination. The method may include indicating, to the wireless access network node, a list of capabilities, including the at least one capability, that the wireless terminal device can share from one band or cell to another band or cell. The method may include receiving a communication from the wireless access network node triggering the sharing by Radio Resource Control (RRC) signalling, Medium Access Control Control Element (MAC-CE), or Downlink Control Information (DCI). In various embodiments, the communication from the wireless access network node indicates Secondary Cell (SCell) deactivation and triggers the sharing from the SCell. In other embodiments, the communication from the wireless access network node indicates Secondary Cell (SCell) dormancy and triggers the sharing from the SCell.

In some exemplary implementations, which may be combined with any of the other exemplary implementations disclosed herein, a method performed by a wireless access network node includes receiving an indication of capability sharing information from a wireless terminal device, and communicating with the wireless terminal device in accordance with the capability sharing information. In some embodiments, receiving the indication of the capability sharing information from the wireless terminal device comprises receiving an indication of support of one band combination including the at least one first band and the at least one second band. The method may include transmitting, to the wireless terminal device, a configuration of at least one second band of the wireless terminal device and no configuration of at least one first band of the wireless terminal device. The method may include transmitting, to the wireless terminal device, a configuration of one or more cells in at least one first band and a configuration of one or more cells in at least one second band, wherein all of the one or more cells in the at least one first band of the wireless terminal device are deactivated. The method may include transmitting, to the wireless terminal device, a configuration of at least one first cell and a configuration of at least one second cell, wherein the at least one first cell of the wireless terminal device is deactivated. The method may include transmitting, to the wireless terminal device, a configuration of one or more cells in at least one first band and a configuration of one or more cells in at least one second band, wherein all of the one or more cells in the at least one first band of the wireless terminal device are in a dormant state. The method may include transmitting, to the wireless terminal device, a configuration of at least one first cell and a configuration of at least one second cell, wherein the at least one first cell of the wireless terminal device is in a dormant state. The method may include transmitting, to the wireless terminal device, a configuration of one or more cells in at least one first band and a configuration of one or more cells in at least one second band, wherein all of the one or more cells in the at least one first band of the wireless terminal device are in a discontinuous reception (DRX) off state. The method may include transmitting, to the wireless terminal device, a configuration of at least one first cell and a configuration of at least one second cell, wherein the at least one first cell of the wireless terminal device is in a discontinuous reception (DRX) off state.

In some exemplary implementations, which may be combined with any of the other exemplary implementations disclosed herein, the method may include transmitting, to the wireless terminal device, a configuration of one or more cells in at least one first band and a configuration of one or more cells in at least one second band, wherein all of the one or more cells in the at least one first band of the wireless terminal device are not scheduled in a time unit. The method may include transmitting, to the wireless terminal device, a configuration of one or more cells in at least one first band and a configuration of one or more cells in at least one second band, wherein all of the one or more cells in the at least one first band are configured as downlink in a time unit. The method may include transmitting, to the wireless terminal device, a configuration of one or more cells in at least one first band and a configuration of one or more cells in at least one second band, wherein all of the one or more cells in the at least one first band are configured as uplink in a time unit. The method may include transmitting, to the wireless terminal device, a configuration of at least one first cell and a configuration of at least one second cell, wherein the at least one first cell of the wireless terminal device is not scheduled in a time unit. The method may include transmitting, to the wireless terminal device, a configuration of at least one first cell and a configuration of at least one second cell, wherein the at least one first cell is configured as downlink in a time unit. The method may include transmitting, to the wireless terminal device, a configuration of at least one first cell and a configuration of at least one second cell, wherein the at least one first cell is configured as uplink in a time unit.

In some exemplary implementations, which may be combined with any of the other exemplary implementations disclosed herein, the method may include transmitting, to the wireless terminal device, a configuration of one or more cells in two or more first bands and a configuration of one or more cells in at least one second band, wherein all of the one or more cells in the two or more first bands of the wireless terminal device are deactivated. The method may include transmitting, to the wireless terminal device, a configuration of one or more cells in two or more first bands and a configuration of one or more cells in at least one second band, wherein all of the one or more cells in the two or more first bands of the wireless terminal device are in a dormant state. The method may include transmitting, to the wireless terminal device, a configuration of one or more cells in two or more first bands and a configuration of one or more cells in at least one second band, wherein all of the one or more cells in the two or more first bands of the wireless terminal device are in a discontinuous reception (DRX) off state. The method may include transmitting, to the wireless terminal device, a configuration of one or more cells in two or more first bands and a configuration of one or more cells in at least one second band, wherein all of the one or more cells in the two or more first bands of the wireless terminal device are not scheduled in a time unit. The method may include transmitting, to the wireless terminal device, a configuration of two or more first cells and a configuration of at least one second cell, wherein the two or more first cells of the wireless terminal device are deactivated. The method may include transmitting, to the wireless terminal device, a configuration of two or more first cells and a configuration of at least one second cell, wherein the two or more first cells of the wireless terminal device are in a dormant state. The method may include transmitting, to the wireless terminal device, a configuration of two or more first cells and a configuration of at least one second cell, wherein the two or more first cells of the wireless terminal device are in a discontinuous reception (DRX) off state. The method may include transmitting, to the wireless terminal device, a configuration of two or more first cells and a configuration of at least one second cell, wherein the two or more first cell of the wireless terminal device are not scheduled in a time unit.

In some exemplary implementations, which may be combined with any of the other exemplary implementations disclosed herein, the method may include receiving an indication of a band pair from the wireless terminal device, wherein at least one capability for one band in the band pair can be shared to another band in the band pair. The method may include receiving a sharing direction from the wireless terminal device. The method may include receiving, from the wireless terminal device, an indication of a band including at least one first cell and at least one second cell as a band that supports sharing of at least one capability from the at least one first cell to the at least one second cell. The method may include receiving, from the wireless terminal device, an indication of a band combination comprising at least one first band and at least one second band, wherein at least one capability for one or more bands in the band combination can be shared to another band in the band combination. The method may include receiving, from the wireless terminal device, an indication of a list of capabilities that the wireless terminal device can share from one band or cell to another band or cell. The method may include communicating to the wireless terminal device a communication triggering the sharing by Radio Resource Control (RRC) signalling, Medium Access Control Control Element (MAC-CE), or Downlink Control Information (DCI). In some embodiments, the communication indicates Secondary Cell (SCell) deactivation and triggers the sharing from the SCell. In some embodiments, the communication indicates Secondary Cell (SCell) dormancy and triggers the sharing from the SCell.

In some exemplary implementations, which may be combined with any of the other exemplary implementations disclosed herein, the at least one capability comprises at least one of: a number of Physical Downlink Shared Channel (PDSCH) received in one slot; a number of Physical Uplink Shared Channel (PUSCH) transmitted in one slot; a Downlink (DL) bandwidth; an Uplink (UL) bandwidth; a number of active Bandwidth Part (BWP); a number of configured BWP; a number of Downlink Control Information (DCI) size; a number of Blind decoding/Control Channel Element (BD/CCE) budget; a number of Transmission Configuration Indication (TCI) state; a number of Multiple Input Multiple Output (MIMO) layer; a number of Synchronization Signal Block (SSB) or Channel State Information Reference Signal (CSI-RS); a number of configured-grant PUSCH or Semi Persistent Scheduling (SPS) PDSCH; a number of Hybrid Automatic Repeat reQuest (HARQ) process; or timing info based on SSB or Tracking Reference Signal (TRS).

In some other implementations, an apparatus for wireless communication such as a network device is disclosed. The network device may include one or more processors and one or more memories, wherein the one or more processors are configured to read computer code from the one or more memories to implement any one of the methods above. The apparatus for wireless communication may be the wireless access network node (e.g., base station) or the wireless terminal device (e.g., UE).

In yet some other implementations, a computer program product is disclosed. The computer program product may include a non-transitory computer-readable medium with computer code stored thereupon, the computer code, when executed by one or more processors, causing the one or more processors to implement any one of the methods above.

The above embodiments and other aspects and alternatives of their implementations are explained in greater detail in the drawings, the descriptions, and the claims below.

### BRIEF DESCRIPTION OF THE DRAWINGS

FIG. 1 shows a wireless access network with an exemplary uplink, downlink, and control channel configuration.

FIG. 2 shows various example processing components of the wireless terminal device and the wireless access network node of FIG. 1.

FIG. 3 shows a timing diagram illustrating aspects of the UE capability sharing in accordance with various embodiments.

FIG. 4 shows another timing diagram illustrating aspects of the UE capability sharing in accordance with various embodiments.

FIG. 5 shows another timing diagram illustrating aspects of the UE capability sharing in accordance with various embodiments.

FIG. 6 shows another timing diagram illustrating aspects of the UE capability sharing in accordance with various embodiments.

### DETAILED DESCRIPTION

The technology and examples of implementations and/or embodiments described in this disclosure can be used to facilitate over-the-air radio resource allocation, configuration, and signaling in wireless access networks as well as operational configuration of a UE and/or a base station within the wireless access networks. The term “exemplary” is used to mean “an example of” and unless otherwise stated, does not imply an ideal or preferred example, implementation, or embodiment. Section headers are used in the present disclosure to facilitate understanding of the disclosed implementations and are not intended to limit the disclosed technology in the sections only to the corresponding section. The disclosed implementations may be further embodied in a variety of different forms and, therefore, the scope of this disclosure or claimed subject matter is intended to be construed as not being limited to any of the embodiments set forth below. The various implementations may be embodied as methods, devices, components, systems, or non-transitory computer readable media. Accordingly, embodiments of this disclosure may, for example, take the form of hardware, software, firmware or any combination thereof.

This disclosure is directed to handling transmissions in a wireless cellular access network and is specifically directed to a mechanism for sharing UE capabilities. The various example embodiments provide configurations and signaling to enable a UE to share capabilities from a first band or cell to a second band or cell. In this manner, UE capabilities can be recycled or reallocated from a cell or band that is not activated, not configured, or not scheduled during one time period to another cell or band. As a result, UE capability utilization efficiency can be increased.

### Wireless Network Overview

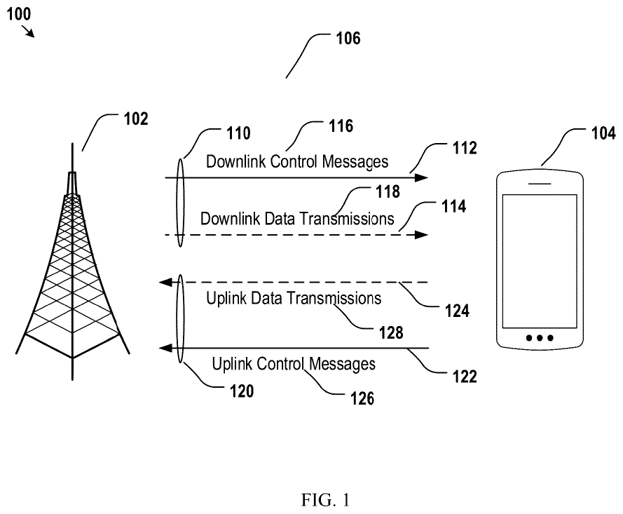

A wireless communication network may include a radio access network for providing network access to wireless terminal devices, and a core network for routing data between the access networks or between the wireless network and other types of data networks. In a wireless access network, radio resources are provided for allocation and used for transmitting data and control information. FIG. 1 shows an exemplary wireless access network 100 including a wireless access network node (WANN) or wireless base station 102 (herein referred to as wireless base station, base station, wireless access node, wireless access network node, or WANN) and a wireless terminal device or user equipment (UE) 104 (herein referred to as user equipment, UE, terminal device, or wireless terminal device) that communicates with one another via over-the-air (OTA) radio communication resources 106. The wireless access network 100 may be implemented as, as for example, a 2G, 3G, 4G/LTE, or 5G cellular radio access network. Correspondingly, the base station 102 may be implemented as a 2G base station, a 3G node B, an LTE eNB, or a 5G New Radio (NR) gNB. The user equipment 104 may be implemented as mobile or fixed communication devices installed with mobile identity modules for accessing the base station 102. The user equipment 104 may include but is not limited to mobile phones, laptop computers, tablets, personal digital assistants, wearable devices, distributed remote sensor devices, and desktop computers. Alternatively, the wireless access network 100 may be implemented as other types of radio access networks, such as Wi-Fi, Bluetooth, ZigBee, and WiMax networks.

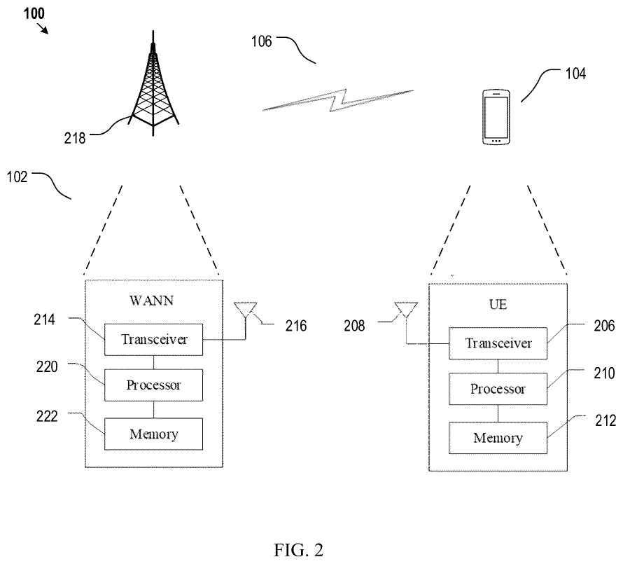

FIG. 2 further shows example processing components of the WANN 102 and the UE 104 of FIG. 1. The UE 104, for example, may include transceiver circuitry 206 coupled to one or more antennas 208 to effectuate wireless communication with the WANN 102 (or to other UEs). The transceiver circuitry 206 may also be coupled to a processor 210, which may also be coupled to a memory 212 or other storage devices. The memory 212 may be transitory or non-transitory and may store therein computer instructions or code which, when read and executed by the processor 210, cause the processor 210 to implement various ones of the, functions, methods, and processes of the UE 104 described herein. The memory 212 may also be utilized and allocated for buffering UL and DL transmissions in each band/carrier. The memory 212 may include multiple memory modules assigned to different functions (such as program memory, base band memory, and/or RF memory, to name a few). Likewise, the WANN 102 may include transceiver circuitry 214 coupled to one or more antennas 216, which may include an antenna tower 218 in various forms, to effectuate wireless communications with the UE 104. The transceiver circuitry 214 may be coupled to one or more processors 220, which may further be coupled to a memory 222 or other storage devices. The memory 222 may be transitory or non-transitory and may store therein instructions or code that, when read and executed by the one or more processors 220, cause the one or more processors 220 to implement various functions, methods, and processes of the WANN 102 described herein.

### Wireless Communication Resource Scheduling/Signaling

Returning to FIG. 1, the radio communication resources for the over-the-air interface 106 may include a combination of frequency, time, and/or spatial communication resources organized into various resource units or elements in frequency, time, and/or space. The radio communication resources 106 in frequency domain may include portions of licensed radio frequency bands, portions of unlicensed ration frequency bands, or portions of a mix of both licensed and unlicensed radio frequency bands. The radio communication resources 106 available for carrying the wireless communication signals between the base station 102 and user equipment 104 may be further divided into physical downlink channels 110 for transmitting wireless signals from the base station 102 to the user equipment 104 and physical uplink channels 120 for transmitting wireless signals from the user equipment 104 to the base station 102. The physical downlink channels 110 may further include physical downlink control channels (PDCCHs) 112 and physical downlink shared channels (PDSCHs) 114. Likewise, the physical uplink channels 120 may further include physical uplink control channels (PUCCHs) 122 and physical uplink shared channels (PUSCHs) 124. For simplification, other types of downlink and uplink channels are not shown in FIG. 1 but are within the scope of the current disclosure. The control channels PDCCHs 112 and PUCCHs 122 may be used for carrying control information in the form of control messages 116 and 126, herein referred to as Downlink Control Information (DCI) messages or Uplink Control Information (UCI) messages. The shared channels (shared between data and control information) PDSCHs 114 and PUSCHs 124 may be allocated and used for communicating downlink data transmissions 118 and uplink data transmissions 128 between the base station 102 and the user equipment 104.

The allocation and configuration of the radio communication resources associated with the data channels, such as the PDSCHs and the PUSCHs may be provided by one or more resource scheduling DCIs carried in the PDCCHs. The PDCCHs may be shared by a plurality of UEs in the access network. In various approaches, a particular UE may be configured to perform blind decode procedures on a preconfigured UE-specific Search Space (USS) to detect and identify a payload of a resource scheduling DCI carried in the PDCCH that specifically targets the particular UE. The blind decoding may be performed on preconfigured monitoring occasions of the PDCCH associated with USS. Such monitoring occasions may be referred to as a set of PDCCH candidates. Each PDCCH candidate may be associated with a set of Control Channel Elements (CCEs). The UE may specifically use its Radio Network Temporary Identifier (RNTI) to decode the PDCCH candidates. The RNTI may be used to demask a PDCCH candidate's CRC. If no CRC error is detected, the UE determines that PDCCH candidate carries its own control information. The UE may then process the DCI and extract the resource allocation information pertaining to the PDSCH and/or PUSCH for receiving and/or transmitting data.

### Description of New UE Capability Sharing Mechanisms

In accordance with the present disclosure, a method is disclosed to enable a UE to share capabilities between bands or cells. In accordance with various embodiments, a method performed by the wireless terminal device or UE 104 for handling transmissions is disclosed. As part of this method, the UE 104 may share at least one capability from at least one first band or cell to at least one second band or cell. The UE 104 may also indicate capability sharing information to a wireless access network node or base station 102. Similarly, a method performed by the wireless access network node or base station 102 includes receiving the indication of capability sharing information from the UE 104, and communicating with the UE 104 in accordance with the capability sharing information.

In various approaches, if the UE 104 indicates support of one band combination including band A and band B, and the UE 104 is configured with cells in band A, but not configured with cells in band B, then the UE capability for band B can be shared to band A. As such, in accordance with various embodiments, indicating the capability sharing information to the base station 102 includes indicating support of one band combination including the at least one first band and the at least one second band to the wireless access network node. The method may further include the base station 102 transmitting, and the UE 104 receiving, a configuration of the at least one second band and no configuration of the at least one first band, and sharing the at least one capability from the at least one first band to the at least one second band.

In another example, if the UE 104 is configured with cells from band A and cells from band B, and if all the cells in band B are deactivated, then the UE capability reported for band B can be shared to band A. As such, the method may include the base station 102 transmitting, and the UE 104 receiving a configuration of one or more cells in the at least one first band and a configuration of one or more cells in the at least one second band, wherein all of the one or more cells in the at least one first band of the wireless terminal device are deactivated. The UE 104 may then determine that all of the one or more cells in the at least one first band are deactivated, and share the at least one capability from the at least one first band to the at least one second band.

Similarly, if the UE 104 is configured with cells including cell M and cell N, if the cell N is deactivated, then the UE capability for cell N can be shared to cell M. The cell M and cell N may be in the same band or in different bands. As such, the method may include the base station 102 transmitting, and the UE 104 receiving a configuration of the at least one first cell and a configuration of the at least one second cell, wherein the at least one first cell of the wireless terminal device is deactivated. The UE 104 may then determine that the at least one first cell is deactivated, and share the at least one capability from the at least one first cell to the at least one second cell, wherein the at least one first cell and the at least one second cell are in a same band or two separate bands.

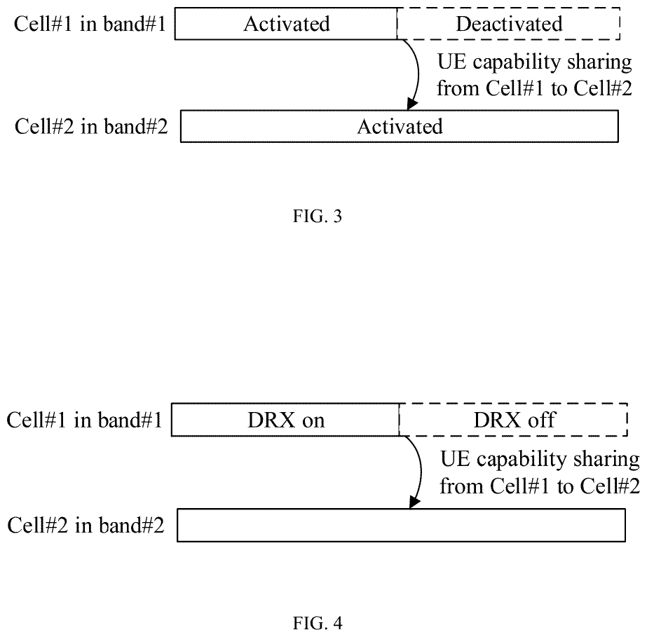

Referring to FIG. 3 as an example, the UE 104 is configured with cell #1 and cell #2 in band #1 and band #2, respectively. If cell #1 is deactivated, the UE capability for cell #1 can be shared to cell #2.

The cell can be activated and deactivated, e.g., by MAC-CE (Medium Access Control Control Element). If the cell is activated, the UE 104 may perform DL and/or UL transmission in this cell. If the cell is deactivated, the UE is not required to perform DL or UL transmission except for some regular measurement in this cell.

In another embodiment, if the UE 104 is configured with cells from band A and cells from band B, and if all the cells in band B are in dormant state, then the UE capability reported for band B can be shared to band A. As such, the method may include the base station 102 transmitting, and the UE 104 receiving a configuration of one or more cells in at least one first band and a configuration of one or more cells in at least one second band, wherein all of the one or more cells in the at least one first band of the wireless terminal device are in a dormant state. The UE 104 may then determine that all of the one or more cells in the at least one first band are in a dormant state, and share the at least one capability from the at least one first band to the at least one second band.

Similarly, if the UE 104 is configured with cells including cell M and cell N, if the cell N is in a dormant state, then the UE capability for cell N can be shared to cell M. The cell M and cell N may be in the same band or in different bands. As such, the method may include the base station 102 transmitting, and the UE 104 receiving a configuration of at least one first cell and a configuration of at least one second cell, wherein the at least one first cell of the wireless terminal device is in a dormant state. The UE 104 may then determine that the at least one first cell is in a dormant state, and share the at least one capability from the at least one first cell to the at least one second cell, wherein the at least one first cell and the at least one second cell are in a same band or two separate bands.

The cell can be in a dormant state or in a non-dormant state. The base station 102 may indicate the cell to go into dormant state by high layer signaling or by switching the active BWP (Bandwidth Part) in this cell to dormant BWP. If the cell is in non-dormant state, the UE 104 may perform DL and/or UL transmission in this cell. If the cell is in a dormant state, the UE 104 is not required to perform DL or UL transmission except for some periodic measurement in this cell.

In another embodiment, if the UE 104 is configured with cells from band A and cells from band B, and if all the cells in band B are in a discontinuous reception (DRX) off state, then the UE capability reported for band B can be shared to band A. As such, the method may include the base station 102 transmitting, and the UE 104 receiving a configuration of one or more cells in at least one first band and a configuration of one or more cells in at least one second band, wherein all of the one or more cells in the at least one first band of the wireless terminal device are in a discontinuous reception (DRX) off state. The UE 104 may then determine that all of the one or more cells in the at least one first band are in a discontinuous reception (DRX) off state, and share the at least one capability from the at least one first band to the at least one second band.

Similarly, if the UE 104 is configured with cells including cell M and cell N, if the cell N is in a DRX off state, then the UE capability for cell N can be shared to cell M. The cell M and cell N may be in the same band or in different bands. As such, the method may include the base station 102 transmitting, and the UE 104 receiving a configuration of at least one first cell and a configuration of at least one second cell, wherein the at least one first cell of the wireless terminal device is in a DRX off state. Then, the UE 104 may determine that the at least one first cell is in a DRX off state, and share the at least one capability from the at least one first cell to the at least one second cell, wherein the at least one first cell and the at least one second cell are in a same band or two separate bands.

During the DRX off state, the UE 104 is not required to monitor the PDCCH (Physical Downlink Control Channel) for at least C-RNTI (Cell Radio Network Temporary Identifier). In this case, at least the PDCCH-related UE capabilities can be shared from the cell in the DRX off state to another cell. During the DRX on state, the UE 104 may need to monitor PDCCH for at least C-RNTI. In this case, the UE 104 may stop UE capabilities sharing from this cell to another cell.

Referring to FIG. 4 as an example, the UE 104 is configured with cell #1 and cell #2 in band #1 and band #2, respectively. If cell #1 goes into DRX off state, the UE capability for cell #1 can be shared to cell #2.

In another embodiment, if the UE 104 is configured with cells from band A and cells from band B, and if all the cells in band B are not scheduled in one time unit (e.g., a slot), then the UE capability reported for band B can be shared to band A in this time unit. As such, the method may include the base station 102 transmitting, and the UE 104 receiving a configuration of one or more cells in at least one first band and a configuration of one or more cells in at least one second band, wherein all of the one or more cells in the at least one first band of the wireless terminal device are not scheduled in a time unit. The UE 104 may then determine that all of the one or more cells in the at least one first band are not scheduled in a time unit, and share the at least one capability from the at least one first band to the at least one second band during the time unit.

In another embodiment, if the UE 104 is configured with cells from band A and cells from band B, and all the cells in band B are configured as downlink in one time unit (e.g., a slot), then the uplink-related UE capability reported for band B can be shared to band A in this time unit. As such, the method may include the base station 102 transmitting, and the UE 104 receiving, a configuration of one or more cells in at least one first band and a configuration of one or more cells in at least one second band, wherein all of the one or more cells in the at least one first band are configured as downlink in a time unit. The UE 104 may then determine that all of the one or more cells in the at least one first band are configured as downlink in a time unit, share at least one uplink-related capability from the at least one first band to the at least one second band during the time unit.

In another embodiment, if the UE 104 is configured with cells from band A and cells from band B, and all the cells in band B are configured as uplink in one time unit (e.g., a slot), then the downlink-related UE capability reported for band B can be shared to band A in this time unit. As such, the method may include the base station 102 transmitting, and the UE 104 receiving, a configuration of one or more cells in at least one first band and a configuration of one or more cells in at least one second band, wherein all of the one or more cells in the at least one first band are configured as downlink in a time unit. The UE 104 may then determine that all of the one or more cells in the at least one first band are configured as uplink in a time unit, and sharing at least one downlink-related capability from the at least one first band to the at least one second band during the time unit.

Similarly, if the UE 104 is configured with cells including cell M and cell N, if the cell N is not scheduled in one time unit (e.g., a slot), then the UE capability for cell N can be shared to cell M in this time unit. The cell M and cell N may be in the same band or in different bands. As such, the method may include the base station 102 transmitting, and the UE 104 receiving a configuration of at least one first cell and a configuration of at least one second cell, wherein the at least one first cell of the wireless terminal device is not scheduled in a time unit. The UE 104 may then determine that the at least one first cell is not scheduled in a time unit, and share the at least one capability from the at least one first cell to the at least one second cell during the time unit, wherein the at least one first cell and the at least one second cell are in a same band or two separate bands.

When the UE 104 is not scheduled to transmit uplink in one time unit (e.g., a slot) for a cell, the UE 104 doesn't transit uplink during the time unit. At least the uplink-related UE capability can be shared to another band or cell.

When the UE 104 is not scheduled to receive downlink in one time unit (e.g., a slot) for a cell, the UE 104 doesn't receive downlink during the time unit. At least the downlink-related UE capability can be shared to another band or cell.

In another embodiment, if the UE 104 is configured with cells including cell M and cell N, if the cell M is configured as downlink in one time unit (e.g., a slot), then the uplink-related UE capability for cell M can be shared to cell N in this time unit. As such, the method may include the base station 102 transmitting, and the UE 104 receiving, a configuration of at least one first cell and a configuration of at least one second cell, wherein the at least one first cell is configured as downlink in a time unit. The UE 104 may then determine that the at least one first cell is configured as downlink in a time unit, and share at least one uplink-related capability from the at least one first cell to the at least one second cell during the time unit, wherein the at least one first cell and the at least one second cell are in a same band or two separate bands.

In another embodiment, if the UE 104 is configured with cells including cell M and cell N, if the cell M is configured as uplink in one time unit (e.g., a slot), then the downlink-related UE capability for cell M can be shared to cell N in this time unit. As such, the method may include the base station 102 transmitting, and the UE 104 receiving, a configuration of one or more cells in at least one first band and a configuration of one or more cells in at least one second band, wherein all of the one or more cells in the at least one first band are configured as downlink in a time unit. The UE 104 may then determine that the at least one first cell is configured as uplink in a time unit, and share at least one downlink-related capability from the at least one first cell to the at least one second cell during the time unit, wherein the at least one first cell and the at least one second cell are in a same band or two separate bands

In various embodiments, one time unit may refer to one frame, subframe, slot, mini-slot, a PDCCH monitoring occasion, a PDSCH transmission occasion, a PUSCH transmission occasion, a CSI-RS transmission occasion in time domain, etc. One frame may usually be equal to 10 ms. One subframe may usually be equal to 1 ms. One slot may be equal to 1 ms, 0.5 ms, 0.25 ms, 0.125 ms, or other values depending on the subcarrier spacing. One slot usually contains 14 or 12 symbols. One mini-slot usually contains several symbols, e.g., 2, 4 or 7 symbols. A PDCCH monitoring occasion usually is not larger than 3 symbols. A PDSCH transmission occasion, PUSCH transmission occasion and CSI-RS transmission occasion may be usually equal to several symbols according to the base station scheduling or higher layer configuration.

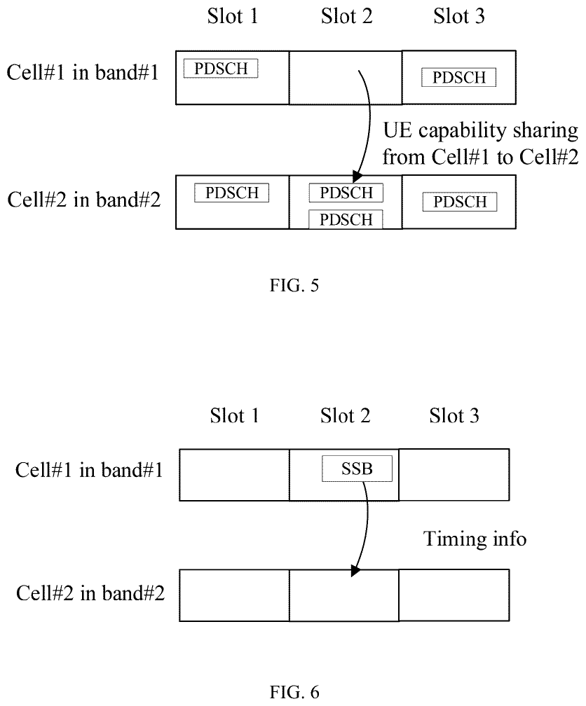

Referring to FIG. 5 as an example. The UE 104 may be configured with two cells, e.g., cell #1 in band #1 and cell #2 in band #2. In this example, the UE 104 can receive up to 1 PDSCH in each slot in each cell. In cell #1, one PDSCH is scheduled in slot 1 and slot 3, respectively. However, in slot 2, no PDSCH is scheduled in cell #1. In this case, the UE capability may be shared from cell #1 to cell #2, i.e., the UE 104 can receive 2 PDSCHs in slot 2 in cell #2.

Although the above only discusses UE capability sharing from one band to another band, similar mechanisms can be applied to a case where UE capabilities from multiple bands can be shared to one band. In the following examples, the UE 104 may be configured with a band combination including K different bands, where K is an integer and K≥3.

In one embodiment, if all the cells in all K bands except for band A are deactivated, then the UE capability from all bands of the K bands, except for band A, can be shared to band A. For example, if the UE 104 is configured with a band combination including band A, band B, and band C, if all the cells in band B and band C are deactivated, then the UE capability from band B and band C can be shared to band A. As such, the method may include the at least one first band comprising two or more first bands, and the base station 102 transmitting, and the UE 104 receiving, a configuration of one or more cells in two or more first bands and a configuration of one or more cells in at least one second band, wherein all of the one or more cells in the two or more first bands of the wireless terminal device are deactivated. The UE 104 may then determine that all of the one or more cells in the two or more first bands are deactivated, and share the at least one capability from at least one of the two or more first bands to the at least one second band.

In another embodiment, if all the cells in all K bands except for band A are in a dormant state, then the UE capability from all bands of the K bands, except for band A, can be shared to band A. For example, if the UE 104 is configured with a band combination including band A, band B, and band C, if all the cells in band B and band C are in the dormant state, then the UE capability from band B and band C can be shared to band A. As such, the method may include the at least one first band comprising two or more first bands, and the base station 102 transmitting, and the UE 104 receiving, a configuration of one or more cells in two or more first bands and a configuration of one or more cells in at least one second band, wherein all of the one or more cells in the two or more first bands of the wireless terminal device are in a dormant state. The UE 104 may then determine that all of the one or more cells in the two or more first bands are in a dormant state, and share the at least one capability from at least one of the two or more first bands to the at least one second band.

In another embodiment, if all the cells in all K bands except for band A are in a DRX off state, then the UE capability from all bands of the K bands, except for band A, can be shared to band A. For example, if the UE 104 is configured with a band combination including band A, band B, and band C, if all the cells in band B and band C are in the DRX off state, then the UE capability from band B and band C can be shared to band A. As such, the method may include the at least one first band comprising two or more first bands, and the base station 102 transmitting, and the UE 104 receiving, a configuration of one or more cells in two or more first bands and a configuration of one or more cells in at least one second band, wherein all of the one or more cells in the two or more first bands of the wireless terminal device are in a DRX off state. The UE 104 may then determine that all of the one or more cells in the two or more first bands are in a DRX off state, and share the at least one capability from at least one of the two or more first bands to the at least one second band.

In another embodiment, if all the cells in all K bands except for band A are not scheduled in one time unit, then the UE capability from all bands of the K bands, except for band A, can be shared to band A during that time unit. For example, if the UE 104 is configured with a band combination including band A, band B, and band C, if all the cells in band B and band C are not scheduled in one time unit, then the UE capability from band B and band C can be shared to band A in that time unit. As such, the method may include the at least one first band comprising two or more first bands, and the base station 102 transmitting, and the UE 104 receiving, a configuration of one or more cells in two or more first bands and a configuration of one or more cells in at least one second band, wherein all of the one or more cells in the two or more first bands of the wireless terminal device are not scheduled in a time unit. The UE 104 may then determine that all of the one or more cells in the two or more first bands are not scheduled in a time unit, and share the at least one capability from at least one of the two or more first bands to the at least one second band during the time unit.

In a similar manner as discussed above with respect to multiple bands, although the above only discusses UE capability sharing from one cell to another cell, similar mechanisms can be applied to a case where UE capability from multiple cells can be shared to one cell. In the following examples, the UE 104 may be configured with K cells, where K is an integer and K≥3.

In one embodiment, if all of the K cells except for cell M are deactivated, then the UE capability from all of the K cells, except for cell M, can be shared to cell M. For example, if the UE 104 is configured with cell M, cell N, and cell P, if cell N and cell P are deactivated, then the UE capability from cell N and cell P can be shared to cell M. As such, the method may include the at least one first cell comprising two or more first cells, and the base station 102 transmitting, and the UE 104 receiving, a configuration of two or more first cells and a configuration of at least one second cell, wherein the two or more first cells of the wireless terminal device are deactivated. The UE 104 may then determine that the two or more first cells are deactivated, and share the at least one capability from at least one of the two or more first cells to the at least one second cell, wherein the two or more first cells and the at least one second cell are in a same band or separate bands.

In another embodiment, if all of the K cells except for cell M are in a dormant state, then the UE capability from all of the K cells, except for cell M, can be shared to cell M. For example, if the UE 104 is configured with cell M, cell N, and cell P, if cell N and cell P are in the dormant state, then the UE capability from cell N and cell P can be shared to cell M. As such, the method may include the at least one first cell comprising two or more first cells, and the base station 102 transmitting, and the UE 104 receiving, a configuration of two or more first cells and a configuration of at least one second cell, wherein the two or more first cells of the wireless terminal device are in a dormant state. The UE 104 may then determine that the two or more first cells are in a dormant state, and share the at least one capability from at least one of the two or more first cells to the at least one second cell, wherein the two or more first cells and the at least one second cell are in a same band or separate bands.

In another embodiment, if all of the K cells except for cell M are in a DRX off state, then the UE capability from all of the K cells, except for cell M, can be shared to cell M. For example, if the UE 104 is configured with cell M, cell N, and cell P, if cell N and cell P are in the DRX off, then the UE capability from cell N and cell P can be shared to cell M. As such, the method may include the at least one first cell comprising two or more first cells, and the base station 102 transmitting, and the UE 104 receiving, a configuration of two or more first cells and a configuration of at least one second cell, wherein the two or more first cells of the wireless terminal device are in a DRX off state. The UE 104 may then determine that the two or more first cells are in a DRX off state, and share the at least one capability from at least one of the two or more first cells to the at least one second cell, wherein the two or more first cells and the at least one second cell are in a same band or separate bands.

In another embodiment, if all of the K cells except for cell M are not scheduled in one time unit, then the UE capability from all of the K cells, except for cell M, can be shared to cell M during that time unit. For example, if the UE 104 is configured with cell M, cell N, and cell P, if cell N and cell P are not scheduled in one time unit, then the UE capability from cell N and cell P can be shared to cell M in that time unit. As such, the method may include the at least one first cell comprising two or more first cells, and the base station 102 transmitting, and the UE 104 receiving, a configuration of two or more first cells and a configuration of at least one second cell, wherein the two or more first cell of the wireless terminal device are not scheduled in a time unit. The UE 104 may then determine that the two or more first cells are not scheduled in a time unit, and share the at least one capability from at least one of the two or more first cells to the at least one second cell during the time unit, wherein the two or more first cells and the at least one second cell are in a same band or separate bands.

In accordance with the various embodiments disclosed herein, a configuration of a cell may include configuration for downlink carrier and/or configuration for uplink carrier, e.g., including the frequency location/bandwidth for downlink carrier and/or uplink carrier. The configuration of the cell may also include the detailed channel/signal configuration, e.g., PDSCH/PUSCH configuration. Other configurations for the cell are also contemplated.

In accordance with the various embodiments disclosed herein, at least the following UE capabilities can be shared from one band to another band, or from one cell to another cell:
a number of Physical Downlink Shared Channel (PDSCH) received in one slot;
a number of Physical Uplink Shared Channel (PUSCH) transmitted in one slot;
a Downlink (DL) bandwidth;
an Uplink (UL) bandwidth;
a number of active Bandwidth Part (BWP);
a number of configured BWP;
a number of Downlink Control Information (DCI) size;
a number of Blind decoding/Control Channel Element (BD/CCE) budget;
a number of Transmission Configuration Indication (TCI) state;
a number of Multiple Input Multiple Output (MIMO) layer;
a number of Synchronization Signal Block (SSB) or Channel State Information Reference Signal (CSI-RS);
a number of configured-grant PUSCH or Semi Persistent Scheduling (SPS) PDSCH;
a number of Hybrid Automatic Repeat reQuest (HARQ) process; or
timing info based on SSB or Tracking Reference Signal (TRS).
Downlink-related UE capability may include some or all of at least the following:
a number of Physical Downlink Shared Channel (PDSCH) received in one slot;
a Downlink (DL) bandwidth;
a number of active Bandwidth Part (BWP), e.g., a number of active DL BWP;
a number of configured BWP, e.g., a number of configured DL BWP;
a number of Downlink Control Information (DCI) size;
a number of Blind decoding/Control Channel Element (BD/CCE) budget;
a number of Transmission Configuration Indication (TCI) state;
a number of Multiple Input Multiple Output (MIMO) layer;
a number of Synchronization Signal Block (SSB) or Channel State Information Reference Signal (CSI-RS);
a number of configured-grant PUSCH or Semi Persistent Scheduling (SPS) PDSCH;
a number of Hybrid Automatic Repeat reQuest (HARQ) process; or
timing info based on SSB or Tracking Reference Signal (TRS).

Uplink-related UE capability may include some or all of at least the following:
a number of Physical Uplink Shared Channel (PUSCH) transmitted in one slot;
an Uplink (UL) bandwidth;
a number of active Bandwidth Part (BWP), e.g., a number of active UL BWP;
a number of configured BWP, e.g., a number of configured UL BWP;
a number of Transmission Configuration Indication (TCI) state;
a number of Multiple Input Multiple Output (MIMO) layer;
a number of configured-grant PUSCH or Semi Persistent Scheduling (SPS) PDSCH;
a number of Hybrid Automatic Repeat reQuest (HARQ) process; or
timing info based on SSB or Tracking Reference Signal (TRS).

In various embodiments, the UE 104 may indicate a value (e.g., X1) for band A and a value (e.g., X2) for band B (without sharing) for one UE capability. If the UE capability for band A is shared to band B, then the UE capability becomes X=X1+X2 for band B in certain examples. Put another way, an amount of the at least one capability from the at least one first band or cell may be represented as X1, and an amount of a capability of the at least one second band or cell without sharing may be represented as X2. The method may include sharing the at least one capability from the at least one first band or cell to the at least one second band or cell such that a shared capability of the at least one second band or cell is X, wherein X=X1+X2. The following are specific examples in accordance with this embodiment.

In one example, if the UE 104 can receive 1 PDSCH per slot for band A and can receive 2 PDSCH per slot for band B, if the UE capability for band A is shared to band B, then the UE 104 can receive 3 TDM (Time Domain Multiplexing) PDSCHs per slot for band B in this case. TDM PDSCHs mean that these PDSCHs are not overlapping with each other in time domain. These PDSCHs may or may not be overlapping in frequency domain. In this case, X1=1, X2=2, and X=X1+X2=3.

In another example, if the UE 104 can receive 1 PDSCH per slot for band A and can receive 1 PDSCH per slot for band B, if the UE capability for band A is shared to band B, then the UE 104 can receive 2 FDM (Frequency Domain Multiplexing) PDSCHs per slot for band B in this case. FDM PDSCHs mean that these PDSCHs are not overlapping with each other in frequency domain. These PDSCHs may or may not be overlapping in time domain. In this case, X1=1, X2=1, and X=X1+X2=2. Put another way, the at least one capability from the at least one first band or cell and the capability of the at least one second band or cell is a number of Physical Downlink Shared Channel (PDSCH) per slot, wherein the wireless terminal device receives X=X1+X2 Frequency Domain Multiplexing (FDM) PDSCHs per slot for the at least one second band or cell.

In another example, if the UE 104 can transmit 2 PUSCH per slot for band A and can transmit 1 PUSCH per slot for band B, if the UE capability for band A is shared to band B, then the UE 104 can transmit 3 TDM PUSCHs per slot for band B in this case. TDM PUSCHs mean that these PUSCHs are not overlapping with each other in time domain. These PUSCHs may or may not be overlapping in frequency domain. In this case, X1=2, X2=1, and X=X1+X2=3.

In another example, if the UE 104 can transmit 1 PUSCH per slot for band A and can transmit 1 PUSCH per slot for band B, if the UE capability for band A is shared to band B, then the UE 104 can transmit 2 FDM PUSCHs per slot for band B in this case. FDM PUSCHs mean that these PUSCHs are not overlapping with each other in frequency domain. These PUSCHs may or may not be overlapping in time domain. In this case, X1=1, X2=1, and X=X1+X2=2.

In another example, if the UE 104 can receive downlink channel/signal with up to X1 frequency resources (i.e., frequency bandwidth) for band A and can receive downlink channel/signal with up to X2 frequency resources for band B, if the UE capability for band A is shared to band B, then the UE 104 can receive downlink channel/signal with up to X1+X2 frequency resources for band B. The frequency resources may be in units of RB (Resource Block), RE (Resource Element), Hz (Hertz) etc. For example, if the UE 104 can receive PDSCH with up to 50 MHz (Million Hz) frequency resources for band A and can receive PDSCH with up to 50 MHz frequency resources for band B, if the UE capability for band A is shared to band B, then the UE 104 can receive PDSCH with up to 100 MHz frequency resources for band B.

In another example, if the UE 104 can transmit uplink channel/signal with up to X1 frequency resources (i.e., frequency bandwidth) for band A and can transmit uplink channel/signal with up to X2 frequency resources for band B, if the UE capability for band A is shared to band B, then the UE 104 can transmit uplink channel/signal with up to X1+X2 frequency resources for band B. The frequency resources may be in units of RB (Resource Block), RE (Resource Element), Hz (Hertz) etc. For example, if the UE 104 can transmit PUSCH with up to 50 MHz (Million Hz) frequency resources for band A and can transmit PUSCH with up to 50 MHz frequency resources for band B, if the UE capability for band A is shared to band B, then the UE 104 can transmit PUSCH with up to 100 MHz frequency resources for band B.

In another example, if the UE 104 can activate 1 DL BWP per cell for band A and can activate 1 DL BWP per cell for band B, if the UE capability for band A is shared to band B, then the UE 104 can activate 2 DL BWPs per cell for band B in this case. In this case, X1=1, X2=1, and X=X1+X2=2. Put another way, the at least one capability from the at least one first band or cell and the capability of the at least one second band or cell is a number of Downlink (DL) Bandwidth Part (BWP) per cell, wherein the wireless terminal device can activate X=X1+X2 DL BWPs per cell for the at least one second band or cell.

In another example, if the UE 104 can activate 1 UL BWP per cell for band A and can activate 1 UL BWP per cell for band B, if the UE capability for band A is shared to band B, then the UE 104 can activate 2 UL BWPs per cell for band B in this case. In this case, X1=1, X2=1, and X=X1+X2=2.

In another example, if the UE 104 can be configured with up to 1 DL BWP per cell for band A and can be configured with up to 2 DL BWP per cell for band B, if the UE capability for band A is shared to band B, then the UE 104 can be configured with up to 3 DL BWPs per cell for band B in this case. In this case, X1=1, X2=2, and X=X1+X2=3.

In another example, if the UE 104 can be configured with up to 2 UL BWP per cell for band A and can be configured with up to 1 UL BWP per cell for band B, if the UE capability for band A is shared to band B, then the UE 104 can be configured with up to 3 UL BWPs per cell for band B in this case. In this case, X1=2, X2=1, and X=X1+X2=3.

In another example, if the UE 104 can monitor PDCCH candidates for up to 4 sizes of DCI formats per cell for band A and can monitor PDCCH candidates for up to 4 sizes of DCI formats per cell for band B, if the UE capability for band A is shared to band B, then the UE 104 can monitor PDCCH candidates for up to 8 sizes of DCI formats per cell for band B. In this case, X1=4, X2=4, and X=X1+X2=8.

In another example, if the UE 104 can monitor PDCCH candidates for up to 3 sizes of DCI formats with CRC scrambled by C-RNTI per cell for band A and can monitor PDCCH candidates for up to 3 sizes of DCI formats with CRC scrambled by C-RNTI per cell for band B, if the UE capability for band A is shared to band B, then the UE 104 can monitor PDCCH candidates for up to 6 sizes of DCI formats with CRC scrambled by C-RNTI per cell for band B. In this case, X1=3, X2=3, and X=X1+X2=6.

In another example, if the UE 104 can monitor up to 44 PDCCH candidates per slot per cell for band A and can monitor up to 44 PDCCH candidates per slot per cell for band B, if the UE capability for band A is shared to band B, then the UE 104 can monitor up to 88 PDCCH candidates per slot per cell for band B. In this case, X1=44, X2=44, and X=X1+X2=88.

In another example, if the UE 104 can monitor up to 56 non-overlapped CCEs per slot per slot per cell for band A and can monitor up to 56 non-overlapped CCEs per slot per slot per cell for band B, if the UE capability for band A is shared to band B, then the UE 104 can monitor up to 112 non-overlapped CCEs per slot per slot per cell for band B. In this case, X1=56, X2=56, and X=X1+X2=112.

In another example, if the UE 104 can support up to 2 active TCI (Transmission Configuration Indicator) states per cell for band A and can support up to 4 active TCI states per cell for band B, if the UE capability for band A is shared to band B, the UE 104 can support up to 6 active TCI states per cell for band B. In this case, X1=2, X2=4, and X=X1+X2=6.

In another example, if the UE 104 can receive PDSCH with up to 2 layers for cell for band A and can receive PDSCH with up to 2 layers for cell for band B, if the UE capability for band A is shared to band B, then the UE 104 can receive PDSCH with up to 4 layers for cell for band B. In this case, X1=2, X2=2, and X=X1+X2=4.

In another example, if the UE 104 can transmit PUSCH with up to 2 layers for cell for band A and can transmit PUSCH with up to 2 layers for cell for band B, if the UE capability for band A is shared to band B, then the UE 104 can transmit PUSCH with up to 4 layers for cell for band B. In this case, X1=2, X2=2, and X=X1+X2=4.

In another example, if the UE 104 can measure or monitor with up to 4 SSB or CSI-RS for cell for band A (e.g., for L1-RSRP measurement) and can measure or monitor with up to 4 SSB or CSI-RS for cell for band B, if the UE capability for band A is shared to band B, then the UE 104 can measure or monitor with up to 8 SSB or CSI-RS for cell for band B. In this case, X1=4, X2=4, and X=X1+X2=8.

In another example, if the UE 104 can be configured with up to 4 configured-grant PUSCHs or SPS PDSCHs for cell for band A and can be configured with up to 2 configured-grant PUSCHs or SPS PDSCHs for cell for band B, if the UE capability for band A is shared to band B, the UE 104 can be configured with up to 6 configured-grant PUSCHs or SPS PDSCHs for cell for band B. In this case, X1=4, X2=2, X=X1+X2=6.

In another example, if the UE 104 can be configured with up to 4 configured-grant PUSCHs or SPS PDSCHs for cell for band A and can be configured with up to 2 configured-grant PUSCHs or SPS PDSCHs for cell for band B, if the UE capability for band A is shared to band B, the UE 104 can be configured with up to 6 configured-grant PUSCHs or SPS PDSCHs for cell for band B. In this case, X1=4, X2=2, X=X1+X2=6.

In another example, if the UE 104 supports up to 8 HARQ processes per cell for band A and UE supports up to 8 HARQ processes per cell for band B, if the UE capability for band A is shared to band B, the UE 104 supports up to 16 HARQ processes per cell for band B. In this case, X1=48 X2=8, and X=X1+X2=16.

In various embodiments, the UE 104 may indicate a value (e.g., X1) for cell M and a value (e.g., X2) for cell N (without sharing) for one UE capability. If the UE capability for cell M is shared to cell N, then the UE capability becomes X=X1+X2 for cell N in certain examples. The following are specific examples in accordance with this embodiment.

In one example, if the UE 104 can receive 1 PDSCH per slot for cell M and can receive 2 PDSCH per slot for cell N, if the UE capability for cell M is shared to cell N, then the UE 104 can receive 3 TDM PDSCHs per slot for cell N in this case. In this case, X1=1, X2=2, and X=X1+X2=3.

In another example, if the UE 104 can receive 1 PDSCH per slot for cell M and can receive 1 PDSCH per slot for cell N, if the UE capability for cell M is shared to cell N, then the UE 104 can receive 2 FDM (Frequency Domain Multiplexing) PDSCHs per slot for cell N in this case. FDM PDSCHs mean that these PDSCHs are not overlapping with each other in frequency domain. These PDSCHs may or may not be overlapping in time domain. In this case, X1=1, X2=1, and X=X1+X2=2.

In another example, if the UE 104 can transmit 2 PUSCH per slot for cell M and can transmit 1 PUSCH per slot for cell N, if the UE capability for cell M is shared to cell N, then the UE 104 can transmit 3 TDM PUSCHs per slot for cell N in this case. TDM PUSCHs mean that these PUSCHs are not overlapping with each other in time domain. These PUSCHs may or may not be overlapping in frequency domain. In this case, X1=2, X2=1, and X=X1+X2=3.

In another example, if the UE 104 can transmit 1 PUSCH per slot for cell M and can transmit 1 PUSCH per slot for cell N, if the UE capability for cell M is shared to cell N, then the UE 104 can transmit 2 FDM PUSCHs per slot for cell N in this case. FDM PUSCHs mean that these PUSCHs are not overlapping with each other in frequency domain. These PUSCHs may or may not be overlapping in time domain. In this case, X1=1, X2=1, and X=X1+X2=2.

In another example, if the UE 104 can receive downlink channel/signal with up to X1 frequency resources (i.e., frequency bandwidth) for cell M and can receive downlink channel/signal with up to X2 frequency resources for cell N, if the UE capability for cell M is shared to cell N, then the UE 104 can receive downlink channel/signal with up to X1+X2 frequency resources for cell N. The frequency resources may be in units of RB (Resource Block), RE (Resource Element), Hz (Hertz) etc. For example, if the UE 104 can receive PDSCH with up to 50 MHz (Million Hz) frequency resources for cell M and can receive PDSCH with up to 50 MHz frequency resources for cell N, if the UE capability for band A is shared to band B, then the UE 104 can receive PDSCH with up to 100 MHz frequency resources for cell N.

In another example, if the UE 104 can transmit uplink channel/signal with up to X1 frequency resources (i.e., frequency bandwidth) for cell M and can transmit uplink channel/signal with up to X2 frequency resources for cell N, if the UE capability for cell M is shared to cell N, then the UE 104 can transmit uplink channel/signal with up to X1+X2 frequency resources for cell N. The frequency resources may be in units of RB (Resource Block), RE (Resource Element), Hz (Hertz) etc. For example, if the UE 104 can transmit PUSCH with up to 50 MHz (Million Hz) frequency resources for cell M and can transmit PUSCH with up to 50 MHz frequency resources for cell N, if the UE capability for cell M is shared to cell N, then the UE 104 can transmit PUSCH with up to 100 MHz frequency resources for cell N.

In another example, if the UE 104 can activate 1 DL BWP per cell for cell M and can activate 1 DL BWP per cell for cell N, if the UE capability for cell M is shared to cell N, then the UE 104 can activate 2 DL BWPs per cell for cell N in this case. In this case, X1=1, X2=1, and X=X1+X2=2.

In another example, if the UE 104 can activate 1 UL BWP per cell for cell M and can activate 1 UL BWP per cell for cell N, if the UE capability for cell M is shared to cell N, then the UE 104 can activate 2 UL BWPs per cell for cell N in this case. In this case, X1=1, X2=1, and X=X1+X2=2.

In another example, if the UE 104 can be configured with up to 1 DL BWP per cell for cell M and can be configured with up to 2 DL BWP per cell for cell N, if the UE capability for cell M is shared to cell N, then the UE 104 can be configured with up to 3 DL BWPs per cell for cell N in this case. In this case, X1=1, X2=2, and X=X1+X2=3.

In another example, if the UE 104 can be configured with up to 2 UL BWP per cell for cell M and can be configured with up to 1 UL BWP per cell for cell N, if the UE capability for cell M is shared to cell N, then UE can be configured with up to 3 UL BWPs per cell for cell N in this case. In this case, X1=2, X2=1, X=X1+X2=3.

In another example, if the UE 104 can monitor PDCCH candidates for up to 4 sizes of DCI formats per cell for cell M and can monitor PDCCH candidates for up to 4 sizes of DCI formats per cell for cell N, if the UE capability for cell M is shared to cell N, then the UE 104 can monitor PDCCH candidates for up to 8 sizes of DCI formats per cell for cell N. In this case, X1=4, X2=4, and X=X1+X2=8.

In another example, if the UE 104 can monitor PDCCH candidates for up to 3 sizes of DCI formats with CRC scrambled by C-RNTI per cell for cell M and can monitor PDCCH candidates for up to 3 sizes of DCI formats with CRC scrambled by C-RNTI per cell for cell N, if the UE capability for cell M is shared to cell N, then the UE 104 can monitor PDCCH candidates for up to 6 sizes of DCI formats with CRC scrambled by C-RNTI per cell for cell N. In this case, X1=3, X2=3, and X=X1+X2=6.

In another example, if the UE 104 can monitor up to 44 PDCCH candidates per slot per cell for cell M and can monitor up to 44 PDCCH candidates per slot per cell for cell N, if the UE capability for cell M is shared to cell N, then the UE 104 can monitor up to 88 PDCCH candidates per slot per cell for cell N. In this case, X1=44, X2=44, and X=X1+X2=88.

In another example, if the UE 104 can monitor up to 56 non-overlapped CCEs per slot per slot per cell for cell M and can monitor up to 56 non-overlapped CCEs per slot per slot per cell for cell N, if the UE capability for cell M is shared to cell N, then the UE 104 can monitor up to 112 non-overlapped CCEs per slot per slot per cell for cell N. In this case, X1=56, X2=56, and X=X1+X2=112.

In another example, if the UE 104 can support up to 2 active TCI (Transmission Configuration Indicator) states per cell for cell M and can support up to 4 active TCI states per cell for cell N, if the UE capability for cell M is shared to cell N, the UE 104 can support up to 6 active TCI states per cell for cell N. In this case, X1=2, X2=4, and X=X1+X2=6.

In another example, if the UE 104 can receive PDSCH with up to 2 layers for cell for cell M and can receive PDSCH with up to 2 layers for cell for cell N, if the UE capability for cell M is shared to cell N, then the UE 104 can receive PDSCH with up to 4 layers for cell for cell N. In this case, X1=2, X2=2, and X=X1+X2=4.

In another example, if the UE 104 can transmit PUSCH with up to 2 layers for cell for cell M and can transmit PUSCH with up to 2 layers for cell for cell N, if the UE capability for cell M is shared to cell N, then the UE 104 can transmit PUSCH with up to 4 layers for cell for cell N. In this case, X1=2, X2=2, and X=X1+X2=4.

In another example, if the UE 104 can measure or monitor with up to 4 SSB or CSI-RS for cell for cell M (e.g., for L1-RSRP measurement) and can measure or monitor with up to 4 SSB or CSI-RS for cell for cell N, if the UE capability for cell M is shared to cell N, then the UE 104 can measure or monitor with up to 8 SSB or CSI-RS for cell for cell N. In this case, X1=4, X2=4, and X=X1+X2=8.

In another example, if the UE 104 can be configured with up to 4 configured-grant PUSCHs or SPS PDSCHs for cell for cell M and can be configured with up to 2 configured-grant PUSCHs or SPS PDSCHs for cell for cell N, if the UE capability for cell M is shared to cell N, the UE 104 can be configured with up to 6 configured-grant PUSCHs or SPS PDSCHs for cell for cell N. In this case, X1=4, X2=2, and X=X1+X2=6.

In another example, if the UE 104 can be configured with up to 4 configured-grant PUSCHs or SPS PDSCHs for cell for cell M and can be configured with up to 2 configured-grant PUSCHs or SPS PDSCHs for cell for cell N, if the UE capability for cell M is shared to cell N, the UE 104 can be configured with up to 6 configured-grant PUSCHs or SPS PDSCHs for cell for cell N. In this case, X1=4, X2=2, and X=X1+X2=6.

In another example, if the UE 104 supports up to 8 HARQ processes per cell for cell M and UE supports up to 8 HARQ processes per cell for cell N, if the UE capability for cell M is shared to cell N, the UE 104 supports up to 16 HARQ processes per cell for cell N. In this case, X1=48 X2=8, and X=X1+X2=16.

In various embodiments, the UE 104 may indicate a value (e.g., X1) for band A and a value (e.g., X2) for band B (without sharing) for one UE capability. If the UE capability for band A is shared to band B, then the UE capability becomes X for band B in certain examples, where X2<X<X1+X2. Similarly, the UE 104 may indicate a value (e.g., X1) for cell M and a value (e.g., X2) for cell N (without sharing) for one UE capability. If the UE capability for cell M is shared to cell N, then the UE capability becomes X for cell N in this case, where X2<X<X1+X2. X may be configured by high layer configuration in either case. Put another way, an amount of the at least one capability of the at least one first band or cell may be represented as X1, and an amount of capability of the at least one second band or cell without sharing may be represented as X2. The method may include sharing the at least one capability from the at least one first band or cell to the at least one second band or cell such that a shared capability of the at least one second band or cell is X, wherein X2<X≤X1+X2, and wherein X is configured by high layer configuration.

For example, if the UE 104 supports 2 TCI states for band A and supports 2 TCI states for band B, if the UE capability for band A is shared to band B, the base station 102 may configure the UE 104 such that it supports up to 3 TCI states for band B in case of UE capability sharing. Then the UE capability of number of TCI states becomes 3 for band B in this case.

In another embodiment, if the UE 104 indicates value X1 for one UE capability for a band pair (e.g., band A and band B), if the UE capability is shared from band A to band B, then the UE capability becomes 2*X1 (i.e., 2 times X1). Put another way, the first band and the second band may be a band pair, and an amount of the at least one capability of the at least one first band and an amount of capability of the at least one second band without sharing is represented as X1. The method may further include the UE 104 sharing the at least one capability from the at least one first band to the at least one second band such that a shared capability of the at least one second band is 2*X1.

For example, if the UE 104 indicates supporting 2 active BWPs for a band pair (e.g., band A, band B), if all the cells for band A are deactivated, the UE capability is shared from band A to band B, then the UE 104 supports up to 2 active BWPs for band B in this case.

In another embodiment, if the UE 104 indicates value X1 for one per-UE UE capability, if the UE capability is shared from band A to band B, then the UE capability becomes 2*X1 (i.e., 2 times X1). Put another way, an amount of the at least one capability of the at least one first band and an amount of capability of the at least one second band without sharing is set for the entire UE 104 and is represented as X1. The method may further include the UE 104 sharing the at least one capability from the at least one first band to the at least one second band such that a shared capability of the at least one second band is 2*X1.

Although the above only discusses UE capability sharing from one band to another band, similar mechanism can be applied to the case where UE capability from multiple bands can be shared to one band.

In one embodiment, if the UE 104 is configured with cells in K bands (denoted as B₁, B₂, . . . , B_{K}) (e.g., including the at least one first band and the at least one second band), and the UE 104 indicates values X₁, X₂, . . . , X_{K} for each band for one UE capability, where K is an integer and K≥3, if the UE capability for all bands except for one band (e.g., B₁) is shared to this band (e.g., B₁), then the UE capability becomes X=Σₖ₌₁^{K}Xₖ for this band in this case, where k is an integer and 1≤k≤K. Put another way, the method may include the UE 104 sharing the at least one capability for all K bands except for the second band to the second band such that a shared capability (X) for the second band is X=Σₖ₌₁^{K}Xₖ.

Similarly, if the UE 104 is configured with K cells (denoted as C₁, C₂, . . . , Cₓ) (e.g., including the at least one first cell and the at least one second cell), and the UE 104 indicates value X₁, X₂, . . . , X_{K} for each cell for one UE capability, where K is an integer and K≥3, if the UE capability for all cells except for one cell (e.g., C₁) is shared to this cell (e.g., C₁), then the UE capability becomes X=Σₖ₌₁^{K}Xₖ for this cell in this case, where k is an integer and 1≤k≤K. Put another way, the method may include the UE 104 sharing the at least one capability for all K cells except for the second cell to the second cell such that a shared capability (X) for the second cell is X=Σₖ₌₁^{K}Xₖ.

In another embodiment, if the UE 104 is configured with cells in K bands (denoted as B₁, B₂, . . . , B_{K}) (e.g., including the at least one first band and the at least one second band), and the UE 104 indicates values X₁, X₂, . . . , X_{K} for each band for one UE capability, where K is an integer and K≥3, if the UE capability for all bands except for one band Bₖ is shared to this band Bₖ, then the UE capability becomes X for this band in this case, where k is an integer and 1≤k≤K. X may be configured by high layer configuration, and Xᵢ<X≤X=Σₖ₌₁^{K}Xₖ. Xᵢ is the indicated value for the UE capability for band Bₖ. Put another way, the method may include the UE 104 sharing the at least one capability for all K bands except for the second band to the second band such that a shared capability (X) for the second band is and Xᵢ<X≤Σₖ₌₁^{K}Xₖ, where k is an integer and 1≤k≤K, and Xᵢ is an indicated value for the second band, and wherein X is configured by high layer configuration.

Similarly, if the UE 104 is configured with K cells (denoted as C₁, C₂, . . . , C_{K}) (e.g., including the at least one first cell and the at least one second cell), and the UE 104 indicates value X₁, X₂, . . . , X_{K} for each cell for one UE capability, where K is an integer and K≥3, if the UE capability for all cells except for one cell Cₖ is shared to this cell Cₖ, then the UE capability becomes X for this cell in this case, where k is integer number and 1≤k≤K. X may be configured by high layer configuration, and Xᵢ<X≤X=Σₖ₌₁^{K}Xₖ. Xᵢ is the indicated value for the UE capability for the cell Cₖ. Put another way, the method may include the UE 104 sharing the at least one capability for all K cells except for the second cell to the second cell such that a shared capability (X) for the second cell is and Xᵢ<X≤Σₖ₌₁^{K}Xₖ, where k is an integer and 1≤k≤K and Xᵢ is an indicated value for the second cell, and wherein X is configured by high layer configuration.

In another embodiment, if the UE 104 indicates a value X1 for one UE capability for one band combination including K bands (denoted as B₁, B₂, . . . , B_{K}) (e.g., including the at least one first band and the at least one second band), if the UE capability for all K bands except for one band Bₖ is shared to this band Bₖ, then the UE capability becomes X=K·X1 for this band Bₖ in this case. K is an integer and K≥3. Put another way, the method may include the UE 104 sharing the at least one capability for all K bands except for the second band to the second band such that a shared capability (X) for the second band is X=K·X1.

In another embodiment, if the UE 104 indicates a value X1 for one per-UE UE capability, if the UE capability for K−1 bands is shared to one band, then the UE capability becomes X=K·X1 for this band in this case, where K is integer number and K≥3. Put another way, the method may include the UE 104 sharing the at least one capability for all K bands except for the second band to the second band such that a shared capability (X) for the second band is X=K·X1.

In another embodiment, if the UE capability for band A is shared to band B, the UE 104 may support acquiring timing info for band B based on the SSB (Synchronization Signal Block) or other TRS (Tracking Reference Signal, also known as CSI-RS for tracking) transmitted on band A. Similarly, if the UE capability for cell M is shared to cell N, the UE 104 may support acquiring timing info for cell N based on the SSB or other TRS transmitted on cell M. Stated another way, the method may include the UE 104 acquiring timing information for the at least one second band or cell based on the Synchronization Signal Block (SSB) or other Tracking Reference Signal (TRS) or Channel State Information Reference Signal (CSI-RS) transmitted on the at least one second band or cell.

Typically, the UE 104 may acquire timing info for one cell from the SSB or TRS transmitted in that cell. However, with reference to FIG. 6 as an example, if the UE capability for band #1 is shared to band #2, the UE 104 may acquire timing info from cell #1 in band #1 for cell #2 in band #2.

In various embodiments, the UE 104 may indicate to the base station 102 the band pair that supports UE capability sharing to base station (e.g., a band pair including the at least one first band and the at least one second band). A UE capability for one band in the band pair can be shared to another band in the band pair. For example, if the UE 104 indicates band pair (e.g., band A, band B) to the base station 102, then the UE capability for band A can be shared to band B, and the UE capability for band B can be shared to band A.

In various embodiments, the UE 104 may indicate to the base station 102 the band pair that supports UE capability sharing (e.g., a band pair including the at least one first band and the at least one second band) and a sharing direction (e.g., from the at least one first band to the at least one second band) to base station. For example, if the UE 104 indicates band pair (band A, band B) to the base station 102 and indicates the sharing direction as sharing from band A to band B, then the UE capability for band A can be shared to band B.

In various embodiments, the UE 104 may indicate a band that supports UE capability sharing to the base station 102, and the UE 104 may support UE capability sharing from one cell of this band to another cell of this band. Put another way, the at least one first cell and the at least one second cell may be within a same band, and the method may include the UE 104 indicating, to the base station 102, and the base station 102 receiving, the band including the at least one first cell and the at least one second cell in a band that supports sharing of the at least one capability from the at least one first cell to the at least one second cell. For example, if the UE 104 indicates to the base station 102 that band #1 supports UE capability sharing, the base station 1012 may configure 2 cells (cell #1 and cell #2) in band #1, and the UE 104 supports UE capability sharing from cell #1 to cell #2 and from cell #2 to cell #1.

In various embodiments, the UE 104 may indicate a band combination (e.g., including the at least one first band and the at least one second band) that supports UE capability sharing to the base station 102, wherein the UE 104 may support UE capability sharing from one or more bands of this band combination to another band of this band combination.

In various embodiments, the UE 104 may indicate a list of the UE capabilities that support sharing from one band to another band to the base station 102. For example, the UE 104 may indicate to the base station 102 that UE capability indicating the number of PUSCH transmitted in one slot supports sharing from one band to another band.

Similarly, the UE 104 may indicate at list of the UE capabilities that support sharing from one cell to another cell to the base station 102. For example, the UE 104 may indicate to the base station 102 that UE capability indicating the number of PUSCH transmitted in one slot supports sharing from one cell to another cell.

In various embodiments, the base station 102 may trigger UE capability sharing by Radio Resource Control (RRC) signalling, Medium Access Control Control Element (MAC-CE), or Downlink Control Information (DCI). Put another way, the base station 102 may communicate to the UE 104, and the UE 104 may receive, a communication triggering the sharing by RRC signalling, MAC-CE, or DCI.

In one example, one MAC-CE or DCI may indicate Secondary Cell (SCell) deactivation and triggers UE capability sharing (e.g., from the SCell). For example, one MAC-CE indicates SCell deactivation for cell A and indicates the UE capability sharing from cell A to another cell.

In another example, one DCI may indicate SCell dormancy and triggers UE capability sharing (e.g., from the SCell). For example, one DCI indicates SCell dormancy (i.e., SCell goes into dormant state) for cell A and indicates the UE capability sharing from cell A to another cell.

The following are detailed examples of US capability sharing between bands.

In one example, if the UE 104 can receive 1 PDSCH per slot for band A and can receive 2 PDSCH per slot for band B, one MAC-CE or DCI deactivates all the cells in band A (or one MAC-CE or DCI indicates all cells in band A to go into dormant state) and triggers UE capability for band A sharing to band B, then the UE 104 can receive 3 TDM (Time Domain Multiplexing) PDSCHs per slot for band B in this case.

In one example, if the UE 104 can receive 1 PDSCH per slot for band A and can receive 1 PDSCH per slot for band B, one MAC-CE or DCI deactivates all the cells in band A (or one MAC-CE or DCI indicates all cells in band A to go into dormant state) and triggers UE capability for band A sharing to band B, then the UE 104 can receive 2 FDM (Frequency Domain Multiplexing) PDSCHs per slot for band B in this case.

In one example, if the UE 104 can transmit 2 PUSCH per slot for band A and can transmit 1 PUSCH per slot for band B, one MAC-CE or DCI deactivates all the cells in band A (or one MAC-CE or DCI indicates all cells in band A to go into dormant state) and triggers UE capability for band A sharing to band B, then the UE 104 can transmit 3 TDM PUSCHs per slot for band B in this case.

In one example, if the UE 104 can transmit 1 PUSCH per slot for band A and can transmit 1 PUSCH per slot for band B, one MAC-CE or DCI deactivates all the cells in band A (or one MAC-CE or DCI indicates all cells in band A to go into dormant state) and triggers UE capability for band A sharing to band B, then the UE 104 can transmit 2 FDM PUSCHs per slot for band B in this case.

In another example, if the UE 104 can receive downlink channel/signal with up to X1 frequency resources (i.e., frequency bandwidth) for band A and can receive downlink channel/signal with up to X2 frequency resources for band B, one MAC-CE or DCI deactivates all the cells in band A (or one MAC-CE or DCI indicates all cells in band A to go into dormant state) and triggers UE capability for band A sharing to band B, then the UE 104 can receive downlink channel/signal with up to X1+X2 frequency resources for band B. The frequency resources may be in units of RB (Resource Block), RE (Resource Element), Hz (Hertz) etc.

In another example, if the UE 104 can transmit uplink channel/signal with up to X1 frequency resources (i.e., frequency bandwidth) for band A and can transmit uplink channel/signal with up to X2 frequency resources for band B, one MAC-CE or DCI deactivates all the cells in band A (or one MAC-CE or DCI indicates all cells in band A to go into dormant state) and triggers UE capability for band A sharing to band B, then the UE 104 can transmit uplink channel/signal with up to X1+X2 frequency resources for band B. The frequency resources may be in units of RB (Resource Block), RE (Resource Element), Hz (Hertz) etc.

In one example, if the UE 104 can activate 1 DL BWP per cell for band A and can activate 1 DL BWP per cell for band B, one MAC-CE or DCI deactivates all the cells in band A (or one MAC-CE or DCI indicates all cells in band A to go into dormant state) and triggers UE capability for band A sharing to band B, then the UE 104 can activate 2 DL BWPs per cell for band B in this case.

In one example, if the UE 104 can activate 1 UL BWP per cell for band A and can activate 1 UL BWP per cell for band B, one MAC-CE or DCI deactivates all the cells in band A (or one MAC-CE or DCI indicates all cells in band A to go into dormant state) and triggers UE capability for band A sharing to band B, then the UE 104 can activate 2 UL BWPs per cell for band B in this case.

In one example, if the UE 104 can be configured with up to 1 DL BWP per cell for band A and can be configured with up to 2 DL BWP per cell for band B, one MAC-CE or DCI deactivates all the cells in band A (or one MAC-CE or DCI indicates all cells in band A to go into dormant state) and triggers UE capability for band A sharing to band B, then the UE 104 can be configured with up to 3 DL BWPs per cell for band B in this case.

In one example, if the UE 104 can be configured with up to 2 UL BWP per cell for band A and can be configured with up to 1 UL BWP per cell for band B, one MAC-CE or DCI deactivates all the cells in band A (or one MAC-CE or DCI indicates all cells in band A to go into dormant state) and triggers UE capability for band A sharing to band B, then the UE 104 can be configured with up to 3 UL BWPs per cell for band B in this case.

In one example, if the UE 104 can monitor PDCCH candidates for up to 4 sizes of DCI formats per cell for band A and can monitor PDCCH candidates for up to 4 sizes of DCI formats per cell for band B, one MAC-CE or DCI deactivates all the cells in band A (or one MAC-CE or DCI indicates all cells in band A to go into dormant state) and triggers UE capability for band A sharing to band B, then the UE 104 can monitor PDCCH candidates for up to 8 sizes of DCI formats per cell for band B.

In one example, if the UE 104 can monitor PDCCH candidates for up to 3 sizes of DCI formats with CRC scrambled by C-RNTI per cell for band A and can monitor PDCCH candidates for up to 3 sizes of DCI formats with CRC scrambled by C-RNTI per cell for band B, one MAC-CE or DCI deactivates all the cells in band A (or one MAC-CE or DCI indicates all cells in band A to go into dormant state) and triggers UE capability for band A sharing to band B, then the UE 104 can monitor PDCCH candidates for up to 6 sizes of DCI formats with CRC scrambled by C-RNTI per cell for band B.

In one example, if the UE 104 can monitor up to 44 PDCCH candidates per slot per cell for band A and can monitor up to 44 PDCCH candidates per slot per cell for band B, one MAC-CE or DCI deactivates all the cells in band A (or one MAC-CE or DCI indicates all cells in band A to go into dormant state) and triggers UE capability for band A sharing to band B, then the UE 104 can monitor up to 88 PDCCH candidates per slot per cell for band B.

In one example, if the UE 104 can monitor up to 56 non-overlapped CCEs per slot per slot per cell for band A and can monitor up to 56 non-overlapped CCEs per slot per slot per cell for band B, one MAC-CE or DCI deactivates all the cells in band A (or one MAC-CE or DCI indicates all cells in band A to go into dormant state) and triggers UE capability for band A sharing to band B, then the UE 104 can monitor up to 112 non-overlapped CCEs per slot per slot per cell for band B.

In one example, if the UE 104 can support up to 2 active TCI (Transmission Configuration Indicator) states per cell for band A and can support up to 4 active TCI states per cell for band B, one MAC-CE or DCI deactivates all the cells in band A (or one MAC-CE or DCI indicates all cells in band A to go into dormant state) and triggers UE capability for band A sharing to band B, the UE 104 can support up to 6 active TCI states per cell for band B.

In one example, if the UE 104 can receive PDSCH with up to 2 layers for cell for band A and can receive PDSCH with up to 2 layers for cell for band B, one MAC-CE or DCI deactivates all the cells in band A (or one MAC-CE or DCI indicates all cells in band A to go into dormant state) and triggers UE capability for band A sharing to band B, then the UE 104 can receive PDSCH with up to 4 layers for cell for band B.

In one example, if the UE 104 can transmit PUSCH with up to 2 layers for cell for band A and can transmit PUSCH with up to 2 layers for cell for band B, one MAC-CE or DCI deactivates all the cells in band A (or one MAC-CE or DCI indicates all cells in band A to go into dormant state) and triggers UE capability for band A sharing to band B, then the UE 104 can transmit PUSCH with up to 4 layers for cell for band B.

In one example, if the UE 104 can measure or monitor with up to 4 SSB or CSI-RS for cell for band A (e.g., for L1-RSRP measurement) and can measure or monitor with up to 4 SSB or CSI-RS for cell for band B, one MAC-CE or DCI deactivates all the cells in band A (or one MAC-CE or DCI indicates all cells in band A to go into dormant state) and triggers UE capability for band A sharing to band B, then the UE 104 can measure or monitor with up to 8 SSB or CSI-RS for cell for band B.

In one example, if the UE 104 can be configured with up to 4 configured-grant PUSCHs or SPS PDSCHs for cell for band A and can be configured with up to 2 configured-grant PUSCHs or SPS PDSCHs for cell for band B, one MAC-CE or DCI deactivates all the cells in band A (or one MAC-CE or DCI indicates all cells in band A to go into dormant state) and triggers UE capability for band A sharing to band B, the UE 104 can be configured with up to 6 configured-grant PUSCHs or SPS PDSCHs for cell for band B.

In one example, if the UE 104 can be configured with up to 4 configured-grant PUSCHs or SPS PDSCHs for cell for band A and can be configured with up to 2 configured-grant PUSCHs or SPS PDSCHs for cell for band B, one MAC-CE or DCI deactivates all the cells in band A (or one MAC-CE or DCI indicates all cells in band A to go into dormant state) and triggers UE capability for band A sharing to band B, the UE 104 can be configured with up to 6 configured-grant PUSCHs or SPS PDSCHs for cell for band B.

In one example, if the UE 104 supports up to 8 HARQ processes per cell for band A and UE supports up to 8 HARQ processes per cell for band B, one MAC-CE or DCI deactivates all the cells in band A (or one MAC-CE or DCI indicates all cells in band A to go into dormant state) and triggers UE capability for band A sharing to band B, the UE 104 supports up to 16 HARQ processes per cell for band B.

The following are detailed examples of US capability sharing between cells.

In one example, if the UE 104 can receive 1 PDSCH per slot for cell M and can receive 2 PDSCH per slot for cell N, one MAC-CE or DCI deactivates cell M (or one MAC-CE or DCI indicates cell M to go into dormant state) and triggers UE capability for cell M sharing to cell N, then the UE 104 can receive 3 TDM PDSCHs per slot for cell N in this case.

In one example, if the UE 104 can receive 1 PDSCH per slot for cell M and can receive 1 PDSCH per slot for cell N, one MAC-CE or DCI deactivates cell M (or one MAC-CE or DCI indicates cell M to go into dormant state) and triggers UE capability for cell M sharing to cell N, then the UE 104 can receive 2 FDM PDSCHs per slot for cell N in this case.

In one example, if the UE 104 can transmit 2 PUSCH per slot for cell M and can transmit 1 PUSCH per slot for cell N, one MAC-CE or DCI deactivates cell M (or one MAC-CE or DCI indicates cell M to go into dormant state) and triggers UE capability for cell M sharing to cell N, then the UE 104 can transmit 3 TDM PUSCHs per slot for cell N in this case.

In one example, if the UE 104 can transmit 1 PUSCH per slot for cell M and can transmit 1 PUSCH per slot for cell N, one MAC-CE or DCI deactivates cell M (or one MAC-CE or DCI indicates cell M to go into dormant state) and triggers UE capability for cell M sharing to cell N, then the UE 104 can transmit 2 FDM PUSCHs per slot for cell N in this case.

In another example, if the UE 104 can receive downlink channel/signal with up to X1 frequency resources (i.e., frequency bandwidth) for cell M and can receive downlink channel/signal with up to X2 frequency resources for cell N, one MAC-CE or DCI deactivates cell M (or one MAC-CE or DCI indicates cell M to go into dormant state) and triggers UE capability for cell M sharing to cell N, then the UE 104 can receive downlink channel/signal with up to X1+X2 frequency resources for cell N. The frequency resources may be in units of RB (Resource Block), RE (Resource Element), Hz (Hertz), etc.

In another example, if the UE 104 can transmit uplink channel/signal with up to X1 frequency resources (i.e., frequency bandwidth) for cell M and can transmit uplink channel/signal with up to X2 frequency resources for cell N, one MAC-CE or DCI deactivates cell M (or one MAC-CE or DCI indicates cell M to go into dormant state) and triggers UE capability for cell M sharing to cell N, then the UE 104 can transmit uplink channel/signal with up to X1+X2 frequency resources for cell N. The frequency resources may be in units of RB (Resource Block), RE (Resource Element), Hz (Hertz), etc.

In one example, if the UE 104 can activate 1 DL BWP per cell for cell M and can activate 1 DL BWP per cell for cell N, one MAC-CE or DCI deactivates cell M (or one MAC-CE or DCI indicates cell M to go into dormant state) and triggers UE capability for cell M sharing to cell N, then the UE 104 can activate 2 DL BWPs per cell for cell N in this case.

In one example, if the UE 104 can activate 1 UL BWP per cell for cell M and can activate 1 UL BWP per cell for cell N, one MAC-CE or DCI deactivates cell M (or one MAC-CE or DCI indicates cell M to go into dormant state) and triggers UE capability for cell M sharing to cell N, then the UE 104 can activate 2 UL BWPs per cell for cell N in this case.

In one example, if the UE 104 can be configured with up to 1 DL BWP per cell for cell M and can be configured with up to 2 DL BWP per cell for cell N, one MAC-CE or DCI deactivates cell M (or one MAC-CE or DCI indicates cell M to go into dormant state) and triggers UE capability for cell M sharing to cell N, then the UE 104 can be configured with up to 3 DL BWPs per cell for cell N in this case.

In one example, if the UE 104 can be configured with up to 2 UL BWP per cell for cell M and can be configured with up to 1 UL BWP per cell for cell N, one MAC-CE or DCI deactivates cell M (or one MAC-CE or DCI indicates cell M to go into dormant state) and triggers UE capability for cell M sharing to cell N, then the UE 104 can be configured with up to 3 UL BWPs per cell for cell N in this case.

In one example, if the UE 104 can monitor PDCCH candidates for up to 4 sizes of DCI formats per cell for cell M and can monitor PDCCH candidates for up to 4 sizes of DCI formats per cell for cell N, one MAC-CE or DCI deactivates cell M (or one MAC-CE or DCI indicates cell M to go into dormant state) and triggers UE capability for cell M sharing to cell N, then the UE 104 can monitor PDCCH candidates for up to 8 sizes of DCI formats per cell for cell N.

In one example, if the UE 104 can monitor PDCCH candidates for up to 3 sizes of DCI formats with CRC scrambled by C-RNTI per cell for cell M and can monitor PDCCH candidates for up to 3 sizes of DCI formats with CRC scrambled by C-RNTI per cell for cell N, one MAC-CE or DCI deactivates cell M (or one MAC-CE or DCI indicates cell M to go into dormant state) and triggers UE capability for cell M sharing to cell N, then the UE 104 can monitor PDCCH candidates for up to 6 sizes of DCI formats with CRC scrambled by C-RNTI per cell for cell N.

In one example, if the UE 104 can monitor up to 44 PDCCH candidates per slot per cell for cell M and can monitor up to 44 PDCCH candidates per slot per cell for cell N, one MAC-CE or DCI deactivates cell M (or one MAC-CE or DCI indicates cell M to go into dormant state) and triggers UE capability for cell M sharing to cell N, then the UE 104 can monitor up to 88 PDCCH candidates per slot per cell for cell N.

In one example, if the UE 104 can monitor up to 56 non-overlapped CCEs per slot per slot per cell for cell M and can monitor up to 56 non-overlapped CCEs per slot per slot per cell for cell N, one MAC-CE or DCI deactivates cell M (or one MAC-CE or DCI indicates cell M to go into dormant state) and triggers UE capability for cell M sharing to cell N, then the UE 104 can monitor up to 112 non-overlapped CCEs per slot per slot per cell for cell N.

In one example, if the UE 104 can support up to 2 active TCI (Transmission Configuration Indicator) states per cell for cell M and can support up to 4 active TCI states per cell for cell N, one MAC-CE or DCI deactivates cell M (or one MAC-CE or DCI indicates cell M to go into dormant state) and triggers UE capability for cell M sharing to cell N, the UE 104 can support up to 6 active TCI states per cell for cell N.

In one example, if the UE 104 can receive PDSCH with up to 2 layers for cell for cell M and can receive PDSCH with up to 2 layers for cell for cell N, one MAC-CE or DCI deactivates cell M (or one MAC-CE or DCI indicates cell M to go into dormant state) and triggers UE capability for cell M sharing to cell N, then the UE 104 can receive PDSCH with up to 4 layers for cell for cell N.

In one example, if the UE 104 can transmit PUSCH with up to 2 layers for cell for cell M and can transmit PUSCH with up to 2 layers for cell for cell N, one MAC-CE or DCI deactivates cell M (or one MAC-CE or DCI indicates cell M to go into dormant state) and triggers UE capability for cell M sharing to cell N, then the UE 104 can transmit PUSCH with up to 4 layers for cell for cell N.

In one example, if the UE 104 can measure or monitor with up to 4 SSB or CSI-RS for cell for cell M (e.g., for L1-RSRP measurement) and can measure or monitor with up to 4 SSB or CSI-RS for cell for cell N, one MAC-CE or DCI deactivates cell M (or one MAC-CE or DCI indicates cell M to go into dormant state) and triggers UE capability for cell M sharing to cell N, then the UE 104 can measure or monitor with up to 8 SSB or CSI-RS for cell for cell N.

In one example, if the UE 104 can be configured with up to 4 configured-grant PUSCHs or SPS PDSCHs for cell for cell M and can be configured with up to 2 configured-grant PUSCHs or SPS PDSCHs for cell for cell N, one MAC-CE or DCI deactivates cell M (or one MAC-CE or DCI indicates cell M to go into dormant state) and triggers UE capability for cell M sharing to cell N, the UE 104 can be configured with up to 6 configured-grant PUSCHs or SPS PDSCHs for cell for cell N.

In one example, if the UE 104 can be configured with up to 4 configured-grant PUSCHs or SPS PDSCHs for cell for cell M and can be configured with up to 2 configured-grant PUSCHs or SPS PDSCHs for cell for cell N, one MAC-CE or DCI deactivates cell M (or one MAC-CE or DCI indicates cell M to go into dormant state) and triggers UE capability for cell M sharing to cell N, UE can be configured with up to 6 configured-grant PUSCHs or SPS PDSCHs for cell for cell N.

In one example, if the UE 104 supports up to 8 HARQ processes per cell for cell M and UE supports up to 8 HARQ processes per cell for cell N, one MAC-CE or DCI deactivates cell M (or one MAC-CE or DCI indicates cell M to go into dormant state) and triggers UE capability for cell M sharing to cell N, the UE 104 supports up to 16 HARQ processes per cell for cell N.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation/example/approach” as used herein does not necessarily refer to the same embodiment and the phrase “in another embodiment/implementation/example/approach” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

What is claimed is:

1. A method performed by a wireless terminal device for handling transmissions, the method comprising:
sharing at least one capability from at least one first band or cell to at least one second band or cell; and
indicating capability sharing information to a wireless access network node.

2. The method according to claim 1,
wherein indicating the capability sharing information to the wireless access network node comprises indicating support of one band combination including the at least one first band and the at least one second band to the wireless access network node,
the method comprising:
receiving, from the wireless access network node, a configuration of the at least one second band and no configuration of the at least one first band; and
sharing the at least one capability from the at least one first band to the at least one second band.

3. The method according to claim 1, comprising:
receiving, from the wireless access network node, a configuration of one or more cells in the at least one first band and a configuration of one or more cells in the at least one second band;
determining that all of the one or more cells in the at least one first band are deactivated; and
sharing the at least one capability from the at least one first band to the at least one second band.

4. The method according to claim 1, comprising:
receiving, from the wireless access network node, a configuration of the at least one first cell and a configuration of the at least one second cell;
determining that the at least one first cell is deactivated; and
sharing the at least one capability from the at least one first cell to the at least one second cell,
wherein the at least one first cell and the at least one second cell are in a same band or two separate bands.

5. The method according to claim 1, comprising:
receiving, from the wireless access network node, a configuration of one or more cells in the at least one first band and a configuration of one or more cells in the at least one second band;
determining that all of the one or more cells in the at least one first band are in a dormant state; and
sharing the at least one capability from the at least one first band to the at least one second band.

6. The method according to claim 1, comprising:
receiving, from the wireless access network node, a configuration of the at least one first cell and a configuration of the at least one second cell;
determining that the at least one first cell is in a dormant state; and
sharing the at least one capability from the at least one first cell to the at least one second cell,
wherein the at least one first cell and the at least one second cell are in a same band or two separate bands.

7. The method according to claim 1, comprising:
receiving, from the wireless access network node, a configuration of one or more cells in the at least one first band and a configuration of one or more cells in the at least one second band;
determining that all of the one or more cells in the at least one first band are in a discontinuous reception (DRX) off state; and
sharing the at least one capability from the at least one first band to the at least one second band.

8. The method according to claim 1, comprising:
receiving, from the wireless access network node, a configuration of the at least one first cell and a configuration of the at least one second cell;
determining that the at least one first cell is in a discontinuous reception (DRX) off state; and
sharing the at least one capability from the at least one first cell to the at least one second cell,
wherein the at least one first cell and the at least one second cell are in a same band or two separate bands.

9. The method according to claim 1, comprising:
receiving, from the wireless access network node, a configuration of one or more cells in the at least one first band and a configuration of one or more cells in the at least one second band;
determining that all of the one or more cells in the at least one first band are not scheduled in a time unit; and
sharing the at least one capability from the at least one first band to the at least one second band during the time unit.

10. The method according to claim 1, comprising:
receiving, from the wireless access network node, a configuration of one or more cells in the at least one first band and a configuration of one or more cells in the at least one second band;
determining that all of the one or more cells in the at least one first band are configured as downlink in a time unit; and
sharing at least one uplink-related capability from the at least one first band to the at least one second band during the time unit.

11. The method according to claim 1, comprising:
receiving, from the wireless access network node, a configuration of one or more cells in the at least one first band and a configuration of one or more cells in the at least one second band;
determining that all of the one or more cells in the at least one first band are configured as uplink in a time unit; and
sharing at least one downlink-related capability from the at least one first band to the at least one second band during the time unit.

12. The method according to claim 1, comprising:
receiving, from the wireless access network node, a configuration of the at least one first cell and a configuration of the at least one second cell;
determining that the at least one first cell is not scheduled in a time unit; and
sharing the at least one capability from the at least one first cell to the at least one second cell during the time unit,
wherein the at least one first cell and the at least one second cell are in a same band or two separate bands.

13. The method according to claim 1, comprising:
receiving, from the wireless access network node, a configuration of the at least one first cell and a configuration of the at least one second cell;
determining that the at least one first cell is configured as downlink in a time unit; and
sharing at least one uplink-related capability from the at least one first cell to the at least one second cell during the time unit,
wherein the at least one first cell and the at least one second cell are in a same band or two separate bands.

14. The method according to claim 1, comprising:
receiving, from the wireless access network node, a configuration of the at least one first cell and a configuration of the at least one second cell;
determining that the at least one first cell is configured as uplink in a time unit; and
sharing at least one downlink-related capability from the at least one first cell to the at least one second cell during the time unit,
wherein the at least one first cell and the at least one second cell are in a same band or two separate bands.

15. The method according to claim 1, wherein the at least one first band comprises two or more first bands, the method comprising:
receiving, from the wireless access network node, a configuration of one or more cells in the two or more first bands and a configuration of one or more cells in the at least one second band;
determining that all of the one or more cells in the two or more first bands are deactivated; and
sharing the at least one capability from at least one of the two or more first bands to the at least one second band.

16. The method according to claim 1, wherein the at least one first band comprises two or more first bands, the method comprising:
receiving, from the wireless access network node, a configuration of one or more cells in the two or more first bands and a configuration of one or more cells in the at least one second band;
determining that all of the one or more cells in the two or more first bands are in a dormant state; and
sharing the at least one capability from at least one of the two or more first bands to the at least one second band.

17. The method according to claim 1, wherein the at least one first band comprises two or more first bands, the method comprising:
receiving, from the wireless access network node, a configuration of one or more cells in the two or more first bands and a configuration of one or more cells in the at least one second band;
determining that all of the one or more cells in the two or more first bands are in a discontinuous reception (DRX) off state; and
sharing the at least one capability from at least one of the two or more first bands to the at least one second band.

18. The method according to claim 1, wherein the at least one first band comprises two or more first bands, the method comprising:
receiving, from the wireless access network node, a configuration of one or more cells in the two or more first bands and a configuration of one or more cells in the at least one second band;
determining that all of the one or more cells in the two or more first bands are not scheduled in a time unit; and
sharing the at least one capability from at least one of the two or more first bands to the at least one second band during the time unit.

19. The method according to claim 1, wherein the at least one first cell comprises two or more first cells, the method comprising:
receiving, from the wireless access network node, a configuration of the two or more first cells and a configuration of the at least one second cell;
determining that the two or more first cells are deactivated; and
sharing the at least one capability from at least one of the two or more first cells to the at least one second cell,
wherein the two or more first cells and the at least one second cell are in a same band or separate bands.

20. The method according to claim 1, wherein the at least one first cell comprises two or more first cells, the method comprising:
receiving, from the wireless access network node, a configuration of the two or more first cells and a configuration of the at least one second cell;
determining that the two or more first cells are in a dormant state; and
sharing the at least one capability from at least one of the two or more first cells to the at least one second cell,
wherein the two or more first cells and the at least one second cell are in a same band or separate bands.

21. The method according to claim 1, wherein the at least one first cell comprises two or more first cells, the method comprising:
receiving, from the wireless access network node, a configuration of the two or more first cells and a configuration of the at least one second cell;
determining that the two or more first cells are in a discontinuous reception (DRX) off state; and
sharing the at least one capability from at least one of the two or more first cells to the at least one second cell,
wherein the two or more first cells and the at least one second cell are in a same band or separate bands.

22. The method according to claim 1, wherein the at least one first cell comprises two or more first cells, the method comprising:
receiving, from the wireless access network node, a configuration of the two or more first cells and a configuration of the at least one second cell;
determining that the two or more first cells are not scheduled in a time unit; and
sharing the at least one capability from at least one of the two or more first cells to the at least one second cell during the time unit,
wherein the two or more first cells and the at least one second cell are in a same band or separate bands.

23. The method according to any one of claims 1-22, wherein the at least one capability comprises at least one of:
a number of Physical Downlink Shared Channel (PDSCH) received in one slot;
a number of Physical Uplink Shared Channel (PUSCH) transmitted in one slot;
a Downlink (DL) bandwidth;
an Uplink (UL) bandwidth;
a number of active Bandwidth Part (BWP);
a number of configured BWP;
a number of Downlink Control Information (DCI) size;
a number of Blind decoding/Control Channel Element (BD/CCE) budget;
a number of Transmission Configuration Indication (TCI) state;
a number of Multiple Input Multiple Output (MIMO) layer;
a number of Synchronization Signal Block (SSB) or Channel State Information Reference Signal (CSI-RS);
a number of configured-grant PUSCH or Semi Persistent Scheduling (SPS) PDSCH;
a number of Hybrid Automatic Repeat reQuest (HARQ) process; or
timing info based on SSB or Tracking Reference Signal (TRS).

24. The method according to claim 1, wherein an amount of the at least one capability from the at least one first band or cell is represented as X1, and wherein an amount of a capability of the at least one second band or cell without sharing is represented as X2,
wherein the method comprises sharing the at least one capability from the at least one first band or cell to the at least one second band or cell such that a shared capability of the at least one second band or cell is X, wherein X=X1+X2.

25. The method according to claim 24, wherein the at least one capability from the at least one first band or cell and the capability of the at least one second band or cell is a number of Physical Downlink Shared Channel (PDSCH) per slot, wherein the wireless terminal device receives X=X1+X2 Frequency Domain Multiplexing (FDM) PDSCHs per slot for the at least one second band or cell.

26. The method according to claim 24, wherein the at least one capability from the at least one first band or cell and the capability of the at least one second band or cell is a number of Downlink (DL) Bandwidth Part (BWP) per cell, wherein the wireless terminal device can activate X=X1+X2 DL BWPs per cell for the at least one second band or cell.

27. The method according to claim 1, wherein an amount of the at least one capability of the at least one first band or cell is represented as X1, and wherein an amount of capability of the at least one second band or cell without sharing is represented as X2,
wherein the method comprises sharing the at least one capability from the at least one first band or cell to the at least one second band or cell such that a shared capability of the at least one second band or cell is X, wherein X2<X≤X1+X2, and wherein X is configured by high layer configuration.

28. The method according to claim 1, wherein the first band and the second band are a band pair, and wherein an amount of the at least one capability of the at least one first band and an amount of capability of the at least one second band without sharing is represented as X1, and
wherein the method comprises sharing the at least one capability from the at least one first band to the at least one second band such that a shared capability of the at least one second band is 2*X1.

29. The method according to claim 1, wherein an amount of the at least one capability of the at least one first band and an amount of capability of the at least one second band without sharing is set for the entire wireless terminal device and is represented as X1, and
wherein the method comprises sharing the at least one capability from the at least one first band to the at least one second band such that a shared capability of the at least one second band is 2*X1.

30. The method according to claim 1, wherein the wireless terminal device is configured with cells in K bands, including the at least one first band and the at least one second band, and wherein the wireless terminal device indicates values X₁, X₂, . . . , X_{K} for each band for the at least one capability, where K is an integer and K≥3,
wherein the method further comprises sharing the at least one capability for all K bands except for the second band to the second band such that a shared capability (X) for the second band is X=Xₖ₌₁^{K}Xₖ, where k is an integer and 1≤k≤K.

31. The method according to claim 1, wherein the wireless terminal device is configured with K cells, including the at least one first cell and the at least one second cell, and wherein the wireless terminal device indicates values X₁, X₂, . . . , X_{K} for each cell for the at least one capability, where K is an integer and K≥3,
wherein the method further comprises sharing the at least one capability for all K cells except for the second cell to the second cell such that a shared capability (X) for the second cell is X=Σₖ₌₁^{K}Xₖ, where k is an integer and 1≤k≤K.

32. The method according to claim 1, wherein the wireless terminal device is configured with cells in K bands, including the at least one first band and the at least one second band, and wherein the wireless terminal device indicates values X₁, X₂, . . . , X_{K} for each band for the at least one capability, where K is an integer and K≥3,
wherein the method further comprises sharing the at least one capability for all K bands except for the second band to the second band such that a shared capability (X) for the second band is and Xᵢ<X≤Σₖ₌₁^{K}Xₖ, where k is an integer and 1≤k≤K and Xᵢ is an indicated value for the second band, and wherein X is configured by high layer configuration.

33. The method according to claim 1, wherein the wireless terminal device is configured with K cells, including the at least one first cell and the at least one second cell, and wherein the wireless terminal device indicates values X₁, X₂, . . . , X_{K} for each cell for the at least one capability, where K is an integer and K≥3,
wherein the method further comprises sharing the at least one capability for all K cells except for the second cell to the second cell such that a shared capability (X) for the second cell is and Xᵢ<X≤Σₖ₌₁^{K}Xₖ, where k is an integer and 1≤k≤K and Xᵢ is an indicated value for the second cell, and wherein X is configured by high layer configuration.

34. The method according to claim 1, wherein the wireless terminal device is configured with a combination of K bands, including the at least one first band and the at least one second band, and wherein the wireless terminal device indicates a value X₁ for each band for the at least one capability, where K is an integer and K≥3,
wherein the method further comprises sharing the at least one capability for all K bands except for the second band to the second band such that a shared capability (X) for the second band is X=K·X1.

35. The method according to claim 1, wherein the wireless terminal device is configured with K bands, including the at least one first band and the at least one second band, and wherein the wireless terminal device indicates a per-wireless terminal device value X₁ for each band for the at least one capability, where K is an integer and K≥3,
wherein the method further comprises sharing the at least one capability for all K bands except for the second band to the second band such that a shared capability (X) for the second band is X=K·X1.

36. The method according to claim 1, comprising:
acquiring timing information for the at least one second band or cell based on the Synchronization Signal Block (SSB) or other Tracking Reference Signal (TRS) or Channel State Information Reference Signal (CSI-RS) transmitted on the at least one second band or cell.

37. The method according to claim 1, comprising:
indicating, to the wireless access network node, a band pair including the at least one first band and the at least one second band,
wherein the at least one capability for one band in the band pair can be shared to another band in the band pair.

38. The method according to claim 1, comprising:
indicating, to the wireless access network node, a band pair including the at least one first band and the at least one second band, and a sharing direction from the at least one first band to the at least one second band.

39. The method according to claim 1, wherein the at least one first cell and the at least one second cell are within a same band,
the method comprising indicating, to the wireless access network node, the band including the at least one first cell and the at least one second cell as a band that supports sharing of the at least one capability from the at least one first cell to the at least one second cell.

40. The method according to claim 1, comprising:
indicating, to the wireless access network node, a band combination comprising the at least one first band and the at least one second band,
wherein the at least one capability for one or more bands in the band combination can be shared to another band in the band combination.

41. The method according to claim 1, comprising:
indicating, to the wireless access network node, a list of capabilities, including the at least one capability, that the wireless terminal device can share from one band or cell to another band or cell.

42. The method according to claim 1, comprising:
receiving a communication from the wireless access network node triggering the sharing by Radio Resource Control (RRC) signalling, Medium Access Control Control Element (MAC-CE), or Downlink Control Information (DCI).

43. The method according to claim 42,
wherein the communication from the wireless access network node indicates Secondary Cell (SCell) deactivation and triggers the sharing from the SCell.

44. The method according to claim 24,
wherein the communication from the wireless access network node indicates Secondary Cell (SCell) dormancy and triggers the sharing from the SCell.

45. A method performed by a wireless access network node, the method comprising:
receiving an indication of capability sharing information from a wireless terminal device; and
communicating with the wireless terminal device in accordance with the capability sharing information.

46. The method according to claim 45,
wherein receiving the indication of the capability sharing information from the wireless terminal device comprises receiving an indication of support of one band combination including the at least one first band and the at least one second band,
the method comprising:
transmitting, to the wireless terminal device, a configuration of at least one second band of the wireless terminal device and no configuration of at least one first band of the wireless terminal device.

47. The method according to claim 45, comprising:
transmitting, to the wireless terminal device, a configuration of one or more cells in at least one first band and a configuration of one or more cells in at least one second band, wherein all of the one or more cells in the at least one first band of the wireless terminal device are deactivated.

48. The method according to claim 45, comprising:
transmitting, to the wireless terminal device, a configuration of at least one first cell and a configuration of at least one second cell, wherein the at least one first cell of the wireless terminal device is deactivated.

49. The method according to claim 45, comprising:
transmitting, to the wireless terminal device, a configuration of one or more cells in at least one first band and a configuration of one or more cells in at least one second band, wherein all of the one or more cells in the at least one first band of the wireless terminal device are in a dormant state.

50. The method according to claim 45, comprising:
transmitting, to the wireless terminal device, a configuration of at least one first cell and a configuration of at least one second cell, wherein the at least one first cell of the wireless terminal device is in a dormant state.

51. The method according to claim 45, comprising:
transmitting, to the wireless terminal device, a configuration of one or more cells in at least one first band and a configuration of one or more cells in at least one second band, wherein all of the one or more cells in the at least one first band of the wireless terminal device are in a discontinuous reception (DRX) off state.

52. The method according to claim 45, comprising:
transmitting, to the wireless terminal device, a configuration of at least one first cell and a configuration of at least one second cell, wherein the at least one first cell of the wireless terminal device is in a discontinuous reception (DRX) off state.

53. The method according to claim 45, comprising:
transmitting, to the wireless terminal device, a configuration of one or more cells in at least one first band and a configuration of one or more cells in at least one second band, wherein all of the one or more cells in the at least one first band of the wireless terminal device are not scheduled in a time unit.

54. The method according to claim 45, comprising:
transmitting, to the wireless terminal device, a configuration of one or more cells in at least one first band and a configuration of one or more cells in at least one second band, wherein all of the one or more cells in the at least one first band are configured as downlink in a time unit.

55. The method according to claim 45, comprising:
transmitting, to the wireless terminal device, a configuration of one or more cells in at least one first band and a configuration of one or more cells in at least one second band, wherein all of the one or more cells in the at least one first band are configured as uplink in a time unit.

56. The method according to claim 45, comprising:
transmitting, to the wireless terminal device, a configuration of at least one first cell and a configuration of at least one second cell, wherein the at least one first cell of the wireless terminal device is not scheduled in a time unit.

57. The method according to claim 45, comprising:
transmitting, to the wireless terminal device, a configuration of at least one first cell and a configuration of at least one second cell, wherein the at least one first cell is configured as downlink in a time unit.

58. The method according to claim 45, comprising:
transmitting, to the wireless terminal device, a configuration of at least one first cell and a configuration of at least one second cell, wherein the at least one first cell is configured as uplink in a time unit.

59. The method according to claim 45, comprising:
transmitting, to the wireless terminal device, a configuration of one or more cells in two or more first bands and a configuration of one or more cells in at least one second band, wherein all of the one or more cells in the two or more first bands of the wireless terminal device are deactivated.

60. The method according to claim 45, comprising:
transmitting, to the wireless terminal device, a configuration of one or more cells in two or more first bands and a configuration of one or more cells in at least one second band, wherein all of the one or more cells in the two or more first bands of the wireless terminal device are in a dormant state.

61. The method according to claim 45, comprising:
transmitting, to the wireless terminal device, a configuration of one or more cells in two or more first bands and a configuration of one or more cells in at least one second band, wherein all of the one or more cells in the two or more first bands of the wireless terminal device are in a discontinuous reception (DRX) off state.

62. The method according to claim 45, comprising:
transmitting, to the wireless terminal device, a configuration of one or more cells in two or more first bands and a configuration of one or more cells in at least one second band, wherein all of the one or more cells in the two or more first bands of the wireless terminal device are not scheduled in a time unit.

63. The method according to claim 45, comprising:
transmitting, to the wireless terminal device, a configuration of two or more first cells and a configuration of at least one second cell, wherein the two or more first cells of the wireless terminal device are deactivated.

64. The method according to claim 45, comprising:
transmitting, to the wireless terminal device, a configuration of two or more first cells and a configuration of at least one second cell, wherein the two or more first cells of the wireless terminal device are in a dormant state.

65. The method according to claim 45, comprising:
transmitting, to the wireless terminal device, a configuration of two or more first cells and a configuration of at least one second cell, wherein the two or more first cells of the wireless terminal device are in a discontinuous reception (DRX) off state.

66. The method according to claim 45, comprising:
transmitting, to the wireless terminal device, a configuration of two or more first cells and a configuration of at least one second cell, wherein the two or more first cell of the wireless terminal device are not scheduled in a time unit.

67. The method according to claim 45, comprising:
receiving an indication of a band pair from the wireless terminal device, wherein at least one capability for one band in the band pair can be shared to another band in the band pair.

68. The method according to claim 67, comprising:
receiving a sharing direction from the wireless terminal device.

69. The method according to claim 45, comprising:
receiving, from the wireless terminal device, an indication of a band including at least one first cell and at least one second cell as a band that supports sharing of at least one capability from the at least one first cell to the at least one second cell.

70. The method according to claim 45, comprising:
receiving, from the wireless terminal device, an indication of a band combination comprising at least one first band and at least one second band, wherein at least one capability for one or more bands in the band combination can be shared to another band in the band combination.

71. The method according to claim 45, comprising:
receiving, from the wireless terminal device, an indication of a list of capabilities that the wireless terminal device can share from one band or cell to another band or cell.

72. The method according to claim 45, comprising:
communicating to the wireless terminal device a communication triggering the sharing by Radio Resource Control (RRC) signalling, Medium Access Control Control Element (MAC-CE), or Downlink Control Information (DCI).

73. The method according to claim 72,
wherein the communication indicates Secondary Cell (SCell) deactivation and triggers the sharing from the SCell.

74. The method according to claim 72,
wherein the communication indicates Secondary Cell (SCell) dormancy and triggers the sharing from the SCell.

75. The method according to any one of claims 45-74, wherein the capability sharing information includes an indication that at least one capability can be shared between at least a first band or cell and a second band or cell, wherein the at least one capability comprises at least one of:
a number of Physical Downlink Shared Channel (PDSCH) received in one slot;
a number of Physical Uplink Shared Channel (PUSCH) transmitted in one slot;
a Downlink (DL) bandwidth;
an Uplink (UL) bandwidth;
a number of active Bandwidth Part (BWP);
a number of configured BWP;
a number of Downlink Control Information (DCI) size;
a number of Blind decoding/Control Channel Element (BD/CCE) budget;
a number of Transmission Configuration Indication (TCI) state;
a number of Multiple Input Multiple Output (MIMO) layer;
a number of Synchronization Signal Block (SSB) or Channel State Information Reference Signal (CSI-RS);
a number of configured-grant PUSCH or Semi Persistent Scheduling (SPS) PDSCH;
a number of Hybrid Automatic Repeat reQuest (HARQ) process; or
timing info based on SSB or Tracking Reference Signal (TRS).

76. An apparatus for wireless communication comprising a processor that is configured to carry out the method of any of claims 1 to 75.

77. A non-transitory computer readable medium having code stored thereon, the code when executed by a processor, causing the processor to implement the method recited in any of claims 1 to 75.
